(19) United States
(12) Patent Application Publication
(10) Pub. No.: US 2026/0259516 A1
(43) Pub. Date: Sep. 3, 2026

(54) POSITIVELY-CHARGEABLE TONER FOR DEVELOPING ELECTROSTATIC IMAGES, TONER SET AND IMAGE FORMING METHOD

(71) Applicant: ZEON CORPORATION, Tokyo (JP)

(72) Inventor: Kojiro Akazaki, Tokyo (JP)

(73) Assignee: ZEON CORPORATION, Tokyo (JP)

(21) Appl. No.: 19/163,998

(22) PCT Filed: Nov. 28, 2023
(86) PCT No.: PCT/JP2023/042523

§ 371 Date: Sep. 10, 2025

(30) Foreign Application Priority Data
Mar. 30, 2023 (JP) 2023-054537

(51) Int. Cl. G03G 9/087; G03G 9/08; G03G 9/09; G03G 9/093

(52) U.S. Cl. CPC G03G 9/08711; G03G 9/0819; G03G 9/0827; G03G 9/08755; G03G 9/091; G03G 9/09321; G03G 9/09364

(57) ABSTRACT

To provide a toner which has an excellent balance between low temperature fixability and heat-resistant storage stability, which is less likely to cause fogging, and which can form an image with excellent gloss uniformity. A positively-chargeable toner for developing electrostatic images, comprising colored resin particles which contain a binder resin, a colorant, a release agent, a release agent disperser and a charge control agent, wherein the binder resin comprises a styrene-acrylic resin and a polyester resin; wherein the release agent comprises an ester wax; and wherein the release agent disperser comprises a nonionic surfactant, and a mass of the nonionic surfactant which is present on a surface of toner particles is from 0.1 ppm to 500 ppm with respect to a mass of the toner particles.

### TECHNICAL FIELD

The present disclosure relates to a positively-chargeable toner for developing electrostatic images, which is used to develop an electrostatic latent image in, for example, electrophotography, electrostatic recording, and electrostatic printing.

The present disclosure also relates to a toner set comprising a combination of the positively-chargeable toners for developing electrostatic images and an image forming method using the toner set.

### BACKGROUND ART

In an image forming device such as an electronic photographic device, an electrostatic recording device and an electrostatic printing device, first, an electrostatic latent image formed on the photoconductor is developed using a toner; the toner image is transferred onto a transferring material such as a sheet of paper; and the material is heated to fix the image, thereby obtaining a fixed image.

For the purpose of reducing power consumption by reduction of thermal energy upon the fixation, etc., reducing environmental load, increasing printing speed and so on, a toner for developing electrostatic images (hereinafter, it is simply referred to as “toner”) that can be fixed at lower temperature is required of the image forming device.

For example, Patent Document 1 is directed to provide a toner that is excellent in low temperature fixability, heat resistance, separability in fixing and durability, and it discloses a toner comprising toner particles comprising a binder resin, a colorant, a release agent and a plasticizer, in which the binder resin contains a styrene-acrylic resin, and the average aspect ratio (Aw) of a domain part of the release agent on the cross section of the toner particle is larger than the average aspect ratio (Ac) of a domain part of the plasticizer. In the toner disclosed in Patent Document 1, a microcrystalline wax is used as the release agent.

Patent Document 2 is directed to provide an image forming device that simultaneously satisfies low temperature fixability and environmental stability, and it discloses, as a toner for use in the image forming device, a toner comprising, as a wax, a monoester compound having a specific structure.

Patent Document 3 is directed to provide a toner capable of providing a high image density and excellent charge stability, and it discloses a toner comprising, as a resin constituting a binder resin, a composite resin containing a polyester resin segment, an addition polymer resin segment that is an addition polymerized product of a raw material monomer containing a styrenic compound, and a structural unit which is derived from a bireactive monomer and which is bonded to the polyester resin segment and the addition polymer resin segment via covalent bonds. In the toner disclosed in Patent Document 3, a hydrocarbon wax is used as a release agent.

### CITATION LIST

### Patent Documents

Patent Document 1: Japanese Patent Application Laid-Open (JP-A) No. 2016-206387
Patent Document 2: JP-A No. 2021-86067
Patent Document 3: JP-A No. 2022-164798

### SUMMARY

### Technical Problem

Balanced improvement in both low temperature fixability and heat-resistant storage stability is required of toners. However, a toner with excellent low temperature fixability and heat-resistant storage stability is likely to cause a problem such that fogging is likely to occur.

When a hydrocarbon wax is used alone as a release agent, there is a problem such that gloss unevenness is likely to occur.

An object of the present disclosure is to provide a toner which has an excellent balance between low temperature fixability and heat-resistant storage stability, which is less likely to cause fogging, and which can form an image with excellent gloss uniformity.

Another object of the present disclosure is to provide a toner set which can form a higher-order color image with excellent gloss uniformity and which is less likely cause the peeling of the toner layers of the formed higher-order color image, and to provide an image forming method using the toner set.

### Solution to Problem

As a result of intensive studies with the aim of achieving the above objects, the present inventor found that when a positively-chargeable toner contains, as a binder resin, a combination of a styrene-acrylic resin and a polyester resin and uses, as an ester wax dispersing agent, a specific amount of nonionic surfactant, the toner is excellent in the balance between low temperature fixability and heat-resistant storage stability; fogging is less likely to occur; and an image with excellent gloss uniformity can be formed. Based on this finding, the present inventor achieved the present disclosure.

The positively-chargeable toner for developing electrostatic images according to the present disclosure is a positively-chargeable toner for developing electrostatic images, comprising colored resin particles which contain a binder resin, a colorant, a release agent, a release agent disperser and a charge control agent,
wherein the binder resin comprises a styrene-acrylic resin and a polyester resin;
wherein the release agent comprises an ester wax; and
wherein the release agent disperser comprises a nonionic surfactant, and a mass of the nonionic surfactant which is present on a surface of toner particles is from 0.1 ppm to 500 ppm with respect to a mass of the toner particles.

In an embodiment of the present disclosure, the charge control agent comprises a charge control resin.

In an embodiment of the present disclosure, a mass ratio of the styrene-acrylic resin to the polyester resin (the styrene-acrylic resin:the polyester resin) is from 96:4 to 70:30.

In an embodiment of the present disclosure, the colored resin particles further contain a styrene-based thermoplastic elastomer.

In an embodiment of the present disclosure, the toner particles have an average circularity of 0.96 or more, and they have a particle size distribution (Dv/Dp) of less than 1.3, which is a ratio of a volume average particle diameter (Dv) to number average particle diameter (Dp) of the toner particles.

In an embodiment of the present disclosure, the ester wax comprises a polyfunctional ester compound of a polyhydric alcohol and a fatty acid containing 10 to 22 carbon atoms.

The present inventor also found that the toner set comprising a combination of the toners of the present disclosure can form a higher-order color image with excellent gloss uniformity and is less likely cause the peeling of the toner layers of the formed higher-order color image.

The toner set of the present disclosure is a color toner set comprising positively-chargeable toners of multiple colors for developing electrostatic images,
wherein the positively-chargeable toners of multiple colors for developing electrostatic images comprise at least a yellow toner, a magenta toner and a cyan toner, and
wherein all of the positively-chargeable toners of multiple colors for developing electrostatic images are those of the present disclosure.

The image forming method of the present disclosure is an image forming method for forming an image using the toner set of the present disclosure.

### Advantageous Effects of Invention

According to the present disclosure, there is provided a toner which is excellent in low temperature fixability and heat-resistant storage stability, which is less likely to cause fogging, and which can form an image with excellent gloss uniformity.

According to the present disclosure, there is also provided a toner set which can form a higher-order color image with excellent gloss uniformity and which is less likely cause the peeling of the toner layers of the formed higher-order color image. According to the present disclosure, there is provided an image forming method using the toner set.

### BRIEF DESCRIPTION OF DRAWING

FIG. 1 A schematic view of an example of an image forming device applicable to image formation using the toner set of the present disclosure.

### DESCRIPTION OF EMBODIMENTS

The positively-chargeable toner for developing electrostatic images according to the present disclosure is a positively-chargeable toner for developing electrostatic images, comprising colored resin particles which contain a binder resin, a colorant, a release agent, a release agent disperser and a charge control agent,
wherein the binder resin comprises a styrene-acrylic resin and a polyester resin;
wherein the release agent comprises an ester wax; and
wherein the release agent disperser comprises a nonionic surfactant, and a mass of the nonionic surfactant which is present on a surface of toner particles is from 0.1 ppm to 500 ppm with respect to a mass of the toner particles.

Hereinafter, the positively-chargeable toner for developing electrostatic images according to the present disclosure may be simply referred to as “the toner of the present disclosure”.

Since the toner of the present disclosure contains the combination of the styrene-acrylic resin and the polyester resin as the binder resin, both fixability and charge stability upon environmental changes can be achieved. Accordingly, the toner is excellent in low temperature fixability and is less likely to cause fogging.

In addition, since the toner of the present disclosure uses the ester wax as the release agent and uses the specific amount of the nonionic surfactant as the release agent disperser, the dispersibility of the ester wax in the colored resin particles is improved. As a result, while suppressing a decrease in the heat-resistant storage stability, the low temperature fixability is further improved. In addition, since the toner of the present disclosure uses the ester wax as the release agent, the crystallization speed of the release agent when the fixed toner is quickly cooled down, is slow. Accordingly, gloss unevenness is less likely to occur, and an image with excellent gloss uniformity can be formed.

Also in the toner of the present disclosure, since the amount of the nonionic surfactant used is within the specific range, while improving the dispersibility of the ester wax, the amount of the surfactant remaining on the surface of the toner particles can be sufficiently reduced. When a large amount of the surfactant remains on the toner particle surface, the toner particle surface absorbs moisture and causes the following problem, for example: fogging is likely to occur due to deterioration of chargeability, or blocking is likely to occur. In a high-temperature and high-humidity environment, this problem is more likely to occur since the toner particle surface is likely to absorb moisture. In the toner of the present disclosure, since the amount of the nonionic surfactant present on the toner particle surface is sufficiently small, the toner is excellent in charge stability, is less likely to cause fogging and blocking, and is excellent in heat-resistant storage stability.

As described above, the toner of the present disclosure uses the specific binder resin, release agent and release agent disperser; moreover, the amount of the nonionic surfactant used as the release agent disperser is controlled so that the amount of the nonionic surfactant present on the toner particle surface is within the specific range. Accordingly, the toner of the present disclosure is a toner which is excellent in the balance between low temperature fixability and heat-resistant storage stability and which is less likely to cause fogging. Also, an image with excellent gloss uniformity can be formed by use of the toner of the present disclosure.

In the present disclosure, the heat-resistant storage stability of the toner may be simply referred to as “storage stability”.

Hereinafter, a method for producing the colored resin particles used in the toner of the present disclosure, the colored resin particles, an additive used in the toner of the present disclosure, and the toner particles constituting the toner of the present disclosure will be described in order.

In the present disclosure, “to” which shows a numerical range is used to describe a range in which the numerical values described before and after “to” indicate the lower limit value and the upper limit value, both of which are included in the numerical range.

### 1-1. Method for Producing Colored Resin Particles

In general, methods for producing colored resin particles are broadly classified into dry methods such as a pulverization method and wet methods such as an emulsion polymerization agglomeration method, a suspension polymerization method and a solution suspension method. The wet methods are preferable since a toner having excellent printing properties such as image reproducibility, can be easily obtained. Among the wet methods, polymerization methods such as the emulsion polymerization agglomeration method and the suspension polymerization method are preferable, since a toner having a relatively small particle size distribution in micron order can be easily obtained. Among the polymerization methods, the suspension polymerization method is more preferable.

The emulsion polymerization agglomeration method is a method for producing colored resin particles by polymerizing emulsified polymerizable monomers to obtain a resin microparticle emulsion and aggregating the resulting resin microparticles with a colorant dispersion, etc. The solution suspension method is a method for producing colored resin particles by forming a solution into droplets in an aqueous medium, the solution containing toner components (such as a binder resin and a colorant) dissolved or dispersed in an organic solvent, and removing the organic solvent. Both methods can be carried out by known methods.

The colored resin particles used in the present disclosure can be produced by the wet or dry methods. The wet methods are preferable, and among the wet methods, the suspension polymerization method is particularly preferable. When the suspension polymerization method is employed, the colored resin particles can be produced by the following steps.

### (A) Suspension Polymerization Method

### (A-1) Preparation Step of Polymerizable Monomer Composition

First, a polymerizable monomer, a polyester resin, a colorant, a release agent, a release agent disperser, a charge control agent and, as needed, another additive such as an acidic group-containing acrylic resin, a styrene-based thermoplastic elastomer and a molecular weight modifier are mixed to prepare a polymerizable monomer composition.

For example, in the preparation of the polymerizable monomer composition, a dispersing machine such as an in-line type emulsifying disperser and a media type emulsifying disperser is used for mixing them. The polymerizable monomer composition is preferably prepared by the following method, for example: the polymerizable monomer, the polyester resin, the colorant, the molecular weight modifier and so on are mixed and wet-pulverized by the media type disperser, and the charge control agent, the release agent, the release agent disperser and so on are added to and further mixed with the mixture, thereby preparing the polymerizable monomer composition. By this method, a toner that is excellent in low temperature fixability and heat-resistant storage stability is easily obtained.

### (Polymerizable Monomer)

In the present disclosure, the polymerizable monomer means a monomer or macromonomer having a polymerizable functional group. The styrene-acrylic resin (a binder resin) is made by polymerization of the polymerizable monomer contained in the polymerizable monomer composition. In the present disclosure, the styrene-acrylic resin means a copolymer of an aromatic vinyl monomer and a (meth)acrylic monomer. To the extent that does not impair the effects of the present disclosure, a monomer that is different from the aromatic vinyl monomer or the (meth)acrylic monomer may be further copolymerized. The (meth)acrylic monomer means a monomer containing at least one selected from the group consisting of an acryloyl group and a methacryloyl group.

Each of the aromatic vinyl monomer, (meth)acrylic monomer and different monomer used for the synthesis of the styrene-acrylic resin, may be a monovinyl monomer, a crosslinkable polymerizable monomer or a macromonomer, and it preferably contains a monovinyl monomer as a main component. More specifically, with respect to the total amount (100 parts by mass) of the polymerizable monomer, the content of the monovinyl monomer is preferably 50 parts by mass or more, more preferably 70 parts by mass or more, still more preferably 90 parts by mass or more, even more preferably 95 parts by mass or more, and particularly preferably 98 parts by mass or more.

As the monovinyl monomer, examples include, but are not limited to, aromatic vinyl monomers including styrene and styrene derivatives such as vinyltoluene and α-methylstyrene; (meth)acrylic monomers including acrylic acid esters such as methyl acrylate, ethyl acrylate, propyl acrylate, butyl acrylate, 2-ethylhexyl acrylate and dimethylaminoethyl acrylate, methacrylic acid esters such as methyl methacrylate, ethyl methacrylate, propyl methacrylate, butyl methacrylate, 2-ethylhexyl methacrylate and dimethylaminoethyl methacrylate, acrylamide, methacrylamide, acrylic acid and methacrylic acid; nitrile compounds such as acrylonitrile and methacrylonitrile; and olefins such as ethylene, propylene and butylene. These monovinyl monomers may be used alone or in combination of two or more.

From the viewpoint of improving the charge stability when there is a change in environment and from the viewpoint of the resulting suppression of fogging, the monovinyl monomer preferably contains an aromatic vinyl monomer and at least one selected from the group consisting of an acrylic acid ester and a methacrylic acid ester, and the monovinyl monomer more preferably contains styrene and at least one selected from the group consisting of an acrylic acid ester and a methacrylic acid ester.

The acrylic acid ester is preferably at least one selected from the group consisting of n-butyl acrylate, propyl acrylate and 2-ethylhexyl acrylate. The methacrylic acid ester is preferably at least one selected from the group consisting of n-butyl methacrylate, propyl methacrylate and 2-ethylhexyl methacrylate.

In the total 100 parts by mass of the monovinyl monomer, the total content of the aromatic vinyl monomer, the acrylic acid ester and the methacrylic acid ester is preferably 60 parts by mass or more, more preferably 70 parts by mass or more, still more preferably 80 parts by mass or more, even more preferably 90 parts by mass or more, and particularly preferably more than 99.95 parts by mass.

From the viewpoint of improving the balance between the low temperature fixability and heat-resistant storage stability of the toner and from the viewpoint of suppression of fogging, the monovinyl monomer preferably contains styrene and at least one selected from the group consisting of an acrylic acid ester and a methacrylic acid ester, and the mass ratio of the styrene to the total of the acrylic acid ester and the methacrylic acid ester (styrene:(meth)acrylic acid ester) is preferably in a range of from 50:50 to 90:10, and more preferably in a range of from 60:40 to 80:20.

The structure and amount of each monomer unit constituting the resin can be determined from the composition of the polymerizable monomer used for the synthesis of the resin, or they can be calculated from integrated values obtained by ¹H-NMR measurement.

The polymerizable monomer may contain a macromonomer in combination with the monovinyl monomer. When a macromonomer is contained in the polymerizable monomer, the balance between the storage stability and low temperature fixability of the toner can be improved.

As the macromonomer, examples include, but are not limited to, a reactive oligomer and a reactive polymer, both of which have a polymerizable carbon-carbon unsaturated double bond at the terminal of the molecular chain and usually have a number average molecular weight of from 1,000 to 30,000. As the macromonomer, examples include, but are not limited to, a styrene macromonomer, a styrene-acrylonitrile macromonomer, a polyacrylic acid ester macromonomer and a polymethacrylic acid ester macromonomer. Among them, at least one selected from the group consisting of a polyacrylic acid ester macromonomer and a polymethacrylic acid ester macromonomer is preferably used, since the glass transition temperature (Tg) of the toner can be easily controlled. As the acrylic acid ester used in the polyacrylic acid ester macromonomer, examples include, but are not limited to, the above-mentioned acrylic acid esters usable as the monovinyl monomer. As the methacrylic acid ester used in the polymethacrylic acid ester macromonomer, examples include, but are not limited to, the above-mentioned methacrylic acid esters usable as the monovinyl monomer. Since the glass transition temperature (Tg) of the toner can be easily controlled within the preferable range, it is preferable to appropriately select and use such a macromonomer as the macromonomer, that when the polymerizable monomer includes the macromonomer, the glass transition temperature (Tg) of the obtained binder resin is higher than the case where the polymerizable monomer does not include the macromonomer.

As the macromonomer, a commercially-available product may be used. As the commercially-available product of the macromonomer, examples include, but are not limited to, macromonomer series AA-6, AS-6, AN-6S, AB-6 and AW-6S manufactured by Toagosei Co., Ltd.

The macromonomers may be used alone or in combination of two or more.

When the polymerizable monomer contains the macromonomer, the content of the macromonomer is not particularly limited. The content of the macromonomer is preferably 0.03 parts by mass or more and 5 parts by mass or less, and more preferably 0.05 parts by mass or more and 1 part by mass or less, with respect to 100 parts by mass of the monovinyl monomer.

The polymerizable monomer may contain a crosslinkable polymerizable monomer in combination with the monovinyl monomer. This is preferable because the storage stability and hot offset resistance of the toner can be easily improved when a crosslinkable polymerizable monomer is contained in the polymerizable monomer.

The crosslinkable polymerizable monomer is a monomer containing two or more polymerizable functional groups.

As the crosslinkable polymerizable monomer, examples include, but are not limited to, an aromatic divinyl compound such as divinyl benzene, divinyl naphthalene and derivatives thereof; an ester compound such as ethylene glycol dimethacrylate and diethylene glycol dimethacrylate, in which two or more carboxylic acids are esterified to an alcohol containing two or more hydroxyl groups; a different divinyl compound such as N,N-divinylaniline and divinyl ether; and a compound containing three or more vinyl groups. Of them, an aromatic divinyl compound is preferred.

These crosslinkable polymerizable monomers may be used alone or in combination of two or more.

When the polymerizable monomer contains the crosslinkable polymerizable monomer, the content of the crosslinkable polymerizable monomer is not particularly limited. The content of the crosslinkable polymerizable monomer is preferably 0.05 parts by mass or more and 5 parts by mass or less, more preferably 0.06 parts by mass or more and 1.5 parts by mass or less, and still more preferably 0.08 parts by mass or more and 0.8 parts by mass or less, with respect to 100 parts by mass of the monovinyl monomer.

The content of the polymerizable monomer is not particularly limited. From the viewpoint of improving the balance between the low temperature fixability and heat-resistant storage stability of the toner and from the viewpoint of suppression of fogging, with respect to the total solid content (100 parts by mass) contained in the polymerizable monomer composition, the content of the polymerizable monomer is preferably 60 parts by mass or more and 90 parts by mass or less, more preferably 65 parts by mass or more and 85 parts by mass or less, and still more preferably 70 parts by mass or more and 80 parts by mass or less.

In the present disclosure, the solid content means all components other than the solvent, and a liquid monomer or the like is included in the solid content.

The content of the polymerizable monomer with respect to the total solid content (100 parts by mass) contained in the polymerizable monomer composition, corresponds to the content of the styrene-acrylic resin with respect to 100 parts by mass of the colored resin particles.

### (Polyester Resin)

As the polyester resin, a polyester resin that is generally used as a binder resin in toners can be used without particular limitation. A polyester resin obtained by polycondensation of a carboxylic acid component containing a polycarboxylic acid compound and an alcohol component containing a polyhydric alcohol, is preferably used.

The carboxylic acid component is a compound containing a carboxyl group or a carboxylic acid derivative group. The polycarboxylic acid compound is a compound containing two or more carboxyl groups or carboxylic acid derivative groups per molecule. As the carboxylic acid derivative group, examples include, but are not limited to, an amide group, an ester group, an acid anhydride group and an acid halide.

In the synthesis of the polyester resin, one compound or a combination of two or more compounds may be used as the carboxylic acid component, and one compound or a combination of two or more compounds may be used as the alcohol component.

The polycarboxylic acid compound used for the synthesis of the polyester resin preferably contains at least a cyclic dicarboxylic acid component (B), since a toner which is excellent in the balance between low temperature fixability and heat-resistant storage stability, which is excellent in environmental stability and which is less likely to cause fogging, can be easily obtained.

As the cyclic dicarboxylic acid compound (B), examples include, but are not limited to, an aromatic dicarboxylic acid compound, an alicyclic dicarboxylic acid compound and derivatives thereof. Of them, an alicyclic dicarboxylic acid compound and derivatives thereof are preferred.

As the aromatic dicarboxylic acid compound, examples include, but are not limited to, 1,5-naphthalic acid, 2,6-naphthalic acid, diphenic acid, terephthalic acid, isophthalic acid, phthalic acid, alkyl substituents thereof, and derivatives thereof such as acid anhydrides, halides, esters and amides.

The alicyclic dicarboxylic acid compound is a compound such that an alicyclic structure and two carboxyl groups are present in the molecular structure. The derivative of the alicyclic dicarboxylic acid compound is a compound such that at least one carboxyl group of the alicyclic dicarboxylic acid compound is substituted with a carboxylic acid derivative group.

As the alicyclic structure, examples include, but are not limited to, a single ring such as a cyclopentane ring, a cyclohexane ring, a cycloheptane ring and a cyclohexene ring, and a polycyclic structure such as a norbornane ring and a norbornene ring.

As the preferred alicyclic dicarboxylic acid compound and derivatives thereof, examples include, but are not limited to, an alicyclic dicarboxylic acid compound in which a carboxyl group or a carboxylic acid derivative group is bound to each of the two carbon atoms forming the alicyclic ring. Especially, a compound in which an alkyl group is bound to an alicyclic ring as a substituent, such as the alicyclic dicarboxylic acid represented by the following general formula (1) or (2) and an anhydride thereof is preferred. As the alkyl group bound to an alicyclic ring as the substituent, an alkyl group containing 1 to 8 carbon atoms is preferred, and a methyl group, an ethyl group, a propyl group or an isopropyl group is more preferred.

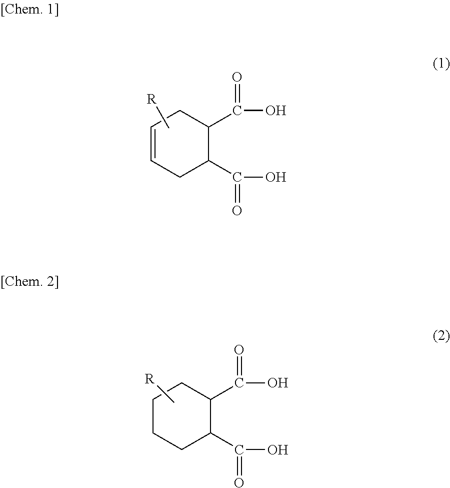

In the formulae (1) and (2), R is an alkyl group.

The alicyclic dicarboxylic acid compound is obtained by, for example, reacting a diene compound (e.g., butadiene, isoprene, piperylene and cyclopentadiene) with maleic anhydride and, as needed, hydrogenating the reaction product.

As the alicyclic dicarboxylic acid compound, examples include, but are not limited to, the following: tetrahydroterephthalic acid, tetrahydroisophthalic acid and tetrahydrophthalic acid; hexahydroterephthalic acid, hexahydroisophthalic acid and hexahydrophtalic acid; 3-alkyltetrahydroterephthalic acid, 4-alkyltetrahydroterephthalic acid, 3-alkyltetrahydroisophthalic acid, 4-alkyltetrahydroisophthalic acid, 3-alkyltetrahydrophthalic acid and 4-alkyltetrahydrophthalic acid; 3-alkylhexahydroterephthalic acid, 4-alkylhexahydroterephthalic acid, 3-alkylhexahydroisophthalic acid, 4-alkylhexahydroisophthalic acid, 3-alkylhexahydrophtalic acid and 4-alkylhexahydrophtalic acid; hexahydroterephthalic acid bis(β-hydroxyethyl); 3,6-endomethylene-tetrahydroterephthalic acid, 3,6-endomethylene-tetrahydroisophthalic acid and 3,6-endomethylene-tetrahydrophthalic acid; 3,6-endomethylene-hexahydroterephthalic acid, 3,6-endomethylene-hexahydroisophthalic acid and 3,6-endomethylene-hexahydrophtalic acid; 2-alkyl-3,6-endomethylene-tetrahydroterephthalic acid, 3-alkyl-3,6-endomethylene-tetrahydroterephthalic acid, 2-alkyl-3,6-endomethylene-tetrahydroisophthalic acid, 3-alkyl-3,6-endomethylene-tetrahydroisophthalic acid, 2-alkyl-3,6-endomethylene-tetrahydrophthalic acid and 3-alkyl-3,6-endomethylene-tetrahydrophthalic acid; 2-alkyl-3,6-endomethylene-hexahydroterephthalic acid and 3-alkyl-3,6-endomethylene-hexahydroterephthalic acid; and 2-alkyl-3,6-endomethylene-hexahydroisophthalic acid, 3-alkyl-3,6-endomethylene-hexahydroisophthalic acid, 2-alkyl-3,6-endomethylene-hexahydrophtalic acid and 3-alkyl-3,6-endomethylene-hexahydrophtalic acid.

As the derivatives of the alicyclic dicarboxylic acid compound, examples include, but are not limited to, an acid anhydride such as tetrahydrophthalic anhydride, hexahydrophthalic anhydride, 3-alkyltetrahydrophthalic anhydride, 3-alkylhexahydrophthalic anhydride, 4-alkyltetrahydrophthalic anhydride and 4-alkylhexahydrophthalic anhydride, a halide, an ester and an amide.

From the viewpoint of improving the low temperature fixability of the toner and from the viewpoint of suppression of fogging, the alicyclic dicarboxylic acid compound and the derivatives thereof are preferably 3-alkyltetrahydrophthalic acid, 3-alkylhexahydrophtalic acid, 4-alkyltetrahydrophthalic acid, 4-alkylhexahydrophtalic acid and anhydrides thereof.

As the cyclic dicarboxylic acid compound (B), a polycarboxylic acid compound (A1) containing an amino group or a salt thereof, may be contained.

As the polycarboxylic acid compound (A1) containing an amino group or a salt thereof, examples include, but are not limited to, an aromatic polycarboxylic acid such as aminoterephthalic acid, 5-aminoisophthalic acid, 5-aminoisophthalic acid methyl ester, 4-aminophthalic acid, 4-aminophthalic anhydride, 4-aminonaphthalene-2,7-dicarboxylic acid and 5-[4-aminophenoxy]isophthalic acid, and an alicyclic polycarboxylic acid such as 5-aminohexahydroisophthalic acid, 5-aminohexahydroisophthalic acid methyl ester, 5-aminohexahydroisophthalic acid dimethyl ester, 4-aminohexahydrophtalic acid, 4-aminohexahydrophtalic anhydride, 5-aminotetrahydroisophthalic acid, 5-aminotetrahydroisophthalic acid methyl ester, 4-aminotetrahydrophthalic acid and 4-aminotetrahydrophthalic anhydride.

The amount of the cyclic dicarboxylic acid compound (B) is preferably from 70% by mole to 100% by mole, and more preferably from 80% by mole to 100% by mole, with respect to the whole carboxylic acid component. When the amount of the cyclic dicarboxylic acid compound (B) is within the range, a toner which is excellent in the balance between low temperature fixability and heat-resistant storage stability, which is excellent in environmental stability, and which is less likely to cause fogging, is easily obtained.

As needed, the carboxylic acid component used for the synthesis of the polyester resin may further contain at least one selected from the group consisting of a chain dicarboxylic acid compound (D) and a trivalent or higher carboxylic acid compound (F).

As the chain dicarboxylic acid compound (D), examples include, but are not limited to, succinic acid, adipic acid, azelaic acid, sebacic acid, dodecanedicarboxylic acid, fumaric acid, maleic acid and itaconic acid.

As the trivalent or higher carboxylic acid compound (F), examples include, but are not limited to, trimellitic acid, pyromellitic acid and trimesic acid.

The amount of the chain dicarboxylic acid compound (D) is preferably 30% by mole or less of the whole carboxylic acid component. As the amount increases, the glass transition temperature or melt viscosity of the toner decreases. Accordingly, the blocking resistance of the toner may decrease, or hot offset may occur.

The amount of the trivalent or higher carboxylic acid compound (F) is preferably 5% by mole or less of the whole carboxylic acid component. As the amount increases, the weight average molecular weight of the polyester resin increases. Accordingly, the melt viscosity of the toner may increase, the fixability of the toner may deteriorate.

The polyhydric alcohol used for the synthesis of the polyester resin preferably contains at least a cyclic dihydric alcohol (C). Accordingly, a toner which is excellent in the balance between low temperature fixability and heat-resistant storage stability, which is excellent in environmental stability and which is less likely to cause fogging, is easily obtained.

As the cyclic dihydric alcohol (C), examples include, but are not limited to, an aromatic dihydric alcohol and an alicyclic dihydric alcohol. Of them, an alicyclic dihydric alcohol is preferred.

As the aromatic dihydric alcohol, examples include, but are not limited to, para-xylylene glycol, meta-xylylene glycol, ortho-xylylene glycol, an ethylene oxide adduct of 1,4-phenylene glycol, an ethylene oxide adduct of bisphenol A, and a propylene oxide adduct of bisphenol A.

As the alicyclic dihydric alcohol, examples include, but are not limited to, 2,2-bis(4-hydroxycyclohexyl)-propane (i.e., hydrogenated bisphenol A), 1,4-bis(hydroxymethyl)cyclohexane, 1,3-bis(hydroxymethyl)cyclohexane, 1,2-bis(hydroxymethyl)cyclohexane, 2,2,4,4-tetramethyl-1,3-cyclohexanediol, 1,4-cyclohexanediol, an ethylene oxide adduct of hydrogenated bisphenol A, a propylene oxide adduct of hydrogenated bisphenol A, tricyclodecanediol, tricyclodecane dimethanol and dicyclohexyl 4,4′-diol. Of them, a bis(hydroxycyclohexyl)-alkane such as hydrogenated bisphenol A is preferred.

The amount of the cyclic dihydric alcohol (C) is preferably from 2% by mole to 100% by mole, more preferably from 10% by mole to 60% by mole, and still more preferably from 20% by mole to 50% by mole of the whole alcohol component. When the amount of the cyclic dihydric alcohol (C) is too small, the glass transition temperature or melt viscosity of the toner decreases. Accordingly, the blocking resistance of the toner may decrease, or hot offset may occur. The fixability of the toner may be improved by decreasing the amount of the alicyclic dihydric alcohol.

The alcohol component used for the synthesis of the polyester resin preferably further contains a chain dihydric alcohol (E). It may further contain a trivalent or higher alcohol (G).

As the chain dihydric alcohol (E), examples include, but are not limited to, a straight-chain aliphatic glycol such as ethylene glycol, diethylene glycol, 1,3-propanediol, 1,4-butanediol, 1,5-pentanediol, 1,6-hexanediol, diethylene glycol, polyethylene glycol and polytetramethylene glycol, and a branched-chain aliphatic glycol such as propylene glycol, dipropylene glycol, polypropylene glycol, neopentyl glycol, 2,2,4-trimethyl-1,3-pentanediol and 2-ethyl-2-butyl-1,3-propanediol. Of them, a straight-chain aliphatic glycol is preferred, and ethylene glycol is particularly preferred.

The amount of the chain dihydric alcohol (E) is preferably from 40% by mole to 98% by mole, and more preferably from 50% by mole to 97% by mole of the whole polyhydric alcohol component forming the polyester resin. When the amount of the chain dihydric alcohol (E) is too small, the melt viscosity of the toner increases, and the fixability thereof may decrease, accordingly. On the other hand, when the amount of the chain dihydric alcohol is too large, the glass transition temperature or melt viscosity of the toner decreases. Accordingly, the blocking resistance of the toner may decrease, or hot offset may occur.

As the trivalent or higher alcohol (G), examples include, but are not limited to, trimethylolpropane, glycerol, pentaerythritol, dipentaerythritol, trimethylolethane, cyclohexanetriol, tris(hydroxymethyl)cyclohexane and 2,4-bis(hydroxyethyl)-1-aminocyclohexane.

The amount of the trivalent or higher alcohol (G) is preferably 5% by mole or less of the whole alcohol component. As the amount increases, the weight average molecular weight of the polyester resin increases. Accordingly, the melt viscosity of the toner may increase, and the fixability of the toner may deteriorate.

As the cyclic dihydric alcohol (C) or the chain dihydric alcohol (E), a polyhydric alcohol (A2) containing an amino group or a salt thereof, may be contained.

As the polyhydric alcohol (A2) containing an amino group or a salt thereof, examples include, but are not limited to, a chain aliphatic polyhydric alcohol such as 2-amino-2-methyl-1,3-propanediol and diethanolamine; an aromatic polyhydric alcohol such as 2-amino-4-hydroxymethylbenzyl alcohol, 2-amino-3-hydroxymethylbenzyl alcohol, 4-amino-2-hydroxymethylbenzyl alcohol and 5-amino-3-hydroxymethylbenzyl alcohol; and ammonium salts thereof.

The polyester resin contained in the toner of the present disclosure is preferably a polyester resin obtained by polycondensation of at least one selected from the group consisting of the polycarboxylic acid compound (A1) containing an amino group or a salt thereof and the polyhydric alcohol (A2) containing an amino group or a salt thereof, since the low temperature fixability of the toner is likely to improve, and fogging is less likely to occur. This polyester resin is preferably a polyester resin containing an amino group or an ammonium salt. The polyester resin containing an ammonium salt may be a polyester resin obtained by polycondensation of one or more selected from the group consisting of the polycarboxylic acid compound (A1) containing an ammonium salt and the polyhydric alcohol (A2) containing an ammonium salt, or it may be a polyester resin obtained by copolycondensing one or more selected from the group consisting of the polycarboxylic acid compound (A1) containing an amino group and the polyhydric alcohol (A2) containing an amino group and ammonium chloridizing the thus-obtained copolycondensate.

In the polyester resin contained in the toner of the present disclosure, the total amount of the polycarboxylic acid compound (A1) containing an amino group or a salt thereof and the polyhydric alcohol (A2) containing an amino group or a salt thereof, is generally from 0.2% by mole to 30% by mole, preferably from 0.5% by mole to 10% by mole, and more preferably from 1.0% by mole to 5% by mole, with respect to 100% by mole of all the monomers (the total of the whole carboxylic acid component and the whole alcohol component) constituting the polyester resin. When at least one selected from the group consisting of the polycarboxylic acid compound (A1) containing an amino group or a salt thereof and the polyhydric alcohol (A2) containing an amino group or a salt thereof is contained as the polycondensation component, the dispersibility of the pigment in the toner can be improved, and the chargeability of the toner can be controlled.

The number average molecular weight Mn of the polyester resin contained in the toner of the present disclosure is preferably from 1,500 to 20,000, more preferably from 2,000 to 10,000, and still more preferably from 2,500 to 8,000. The weight average molecular weight Mw of the polyester resin contained therein is preferably from 5,000 to 300,000, more preferably from 7,000 to 100,000, and still more preferably from 8,000 to 20,000. When the molecular weights are in the ranges, a toner that is excellent in low temperature fixability and hot offset resistance can be obtained. When the number average molecular weight Mn or the weight average molecular weight Mw is smaller than the ranges, the cohesion of the polyester resin may decrease, and the storage stability of the toner may decrease, accordingly. On the other hand, when the molecular weights are larger than the ranges, the productivity of the polyester resin may decrease, and the fixability of the toner may deteriorate, accordingly.

In the present disclosure, the weight average molecular weight Mw and number average molecular weight MN of resin are polystyrene equivalent molecular weights measured by gel permeation chromatography (GPC) using tetrahydrofuran (THF).

The glass transition temperature of the polyester resin is preferably from 40° C. to 90° C., and particularly preferably from 50° C. to 80° C. When the glass transition temperature is within the above range, the storage stability of the toner is improved.

In the present disclosure, the glass transition temperature (Tg) of the resin can be obtained according to ASTM D3418-82, for example. More specifically, using a differential scanning calorimeter (SSC5200 manufactured by Seiko Instruments & Electronics Ltd.) or the like, the temperature of a sample is increased at a temperature increase rate of 10° C./min, thereby obtaining a DSC curve; and the temperature indicating the maximum endothermic peak in the DSC curve can be used as the glass transition temperature.

The hydroxyl value of the polyester resin is generally from 1 mgKOH/g to 100 mgKOH/g, and preferably from 5 mgKOH/g to 80 mgKOH/g. When the hydroxyl value is small, the fixability decreases. As a result, large surface roughness may be formed on the surface of an image, and the smoothness of the image surface may decrease, accordingly. When the hydroxyl value is large, the hot offset occurrence temperature of the toner decreases; moreover, the hydrophilicity of the toner increases, resulting in a tendency for the charge amount of the toner to be changed by environmental changes and in easy occurrence of fogging.

To reduce the influence of water in a high-temperature and high-humidity environment, decreasing the amount of aromatic rings contained in the polyester resin is preferred.

The polyester resin contained in the toner of the present disclosure can be produced by a known method, that is, a polycondensation method. Since the molecular weight and hydroxyl value of the polyester can be easily controlled within the preferred ranges, the polycondensation of the carboxylic acid component and the alcohol component is preferably carried out in the following condition: of the whole monomers (the total of the carboxylic acid component and the alcohol component), the total hydroxyl value (X) of the alcoholic reactive group is not smaller than the total acid value (Y) of the carboxylic acidic reactive group.

The ratio of the total hydroxyl value (X) of the alcoholic reactive group to the total acid value (Y) of the carboxylic acidic reactive group, that is, the (X)/(Y) ratio (equivalent ratio) is preferably 1.00 or more, more preferably from in a range of from 1.01 to 1.5, and particularly preferably in a range of from 1.03 to 1.3. The alcoholic reactive group is an alcoholic functional group involved in ester bond formation, and it is generally a hydroxyl group or the like. The carboxylic acidic reactive group is a carboxylic acidic functional group involved in ester bond formation, and it is generally a carboxyl group, a carboxylic acid derivative group or the like.

The polycondensation reaction is carried out at, for example, a reaction temperature of from 100° C. to 300° C., and preferably from 150° C. to 280° C. It is particularly preferably carried out in the presence of inert gas. As needed, a water-insoluble organic solvent that is azeotropic with water may be used, such as toluene and xylene. The polycondensation reaction may be carried out under reduced pressure (generally from 0.1 mmHg to 500 mmHg, preferably from 0.5 mmHg to 200 mmHg, and more preferably from 1 mmHg to 50 mmHg). In this polycondensation reaction, an esterification catalyst is generally used. As the esterification catalyst, examples include, but are not limited to, a Brønsted acid such as para-toluenesulfonic acid, sulfuric acid and phosphoric acid; calcium acetate, zinc acetate, manganese acetate and zinc stearate; an acetylacetonate of iron or zinc; a metal alkoxide; an organometallic compound such as alkyl tin oxide, dialkyl tin oxide and an organotitanium compound; a metal oxide such as tin oxide, antimony oxide, titanium oxide and vanadium oxide; and a heteropolyoxometalate. Since the molecular weight of the thus-obtained polyester resin can be increased, a titanium alkoxide such as a tetrabutoxy titanate, a heteropolyoxometalate or an iron acetylacetonate is preferred.

To obtain the polyester resin, the carboxylic acid component and the alcohol component may be fed at the desired composition ratio and reacted at once, or they may be gradually reacted for control of the molecular weight. In the case of using at least one selected from the group consisting of the polycarboxylic acid compound (A1) containing an amino group or a salt thereof and the polyhydric alcohol (A2) containing an amino group or a salt thereof, it can be gradually reacted by the following method.

First, a carboxylic acid component containing the cyclic dicarboxylic acid compound (B) is polycondensed with an alcohol component containing the cyclic dihydric alcohol (C) to obtain a precursor. The carboxylic acid component and alcohol component used to obtain the precursor are preferably free of the polycarboxylic acid compound (A1) containing an amino group or a salt thereof and the polyhydric alcohol (A2) containing an amino group or a salt thereof. Also, the carboxylic acid component and alcohol component used to obtain the precursor preferably further contain at least one selected from the group consisting of the chain dicarboxylic acid compound (D) and the chain dihydric alcohol (E).

Next, the obtained precursor, at least one selected from the group consisting of the polycarboxylic acid compound (A1) containing an amino group or a salt thereof and the polyhydric alcohol (A2) containing an amino group or a salt thereof, and at least one selected from the group consisting of a polycarboxylic acid compound (H) and a polyhydric alcohol (I) are polycondensed.

The number average molecular weight of the precursor is from 1,500 to 5,000, preferably from 2,000 to 4,000, which is a polystyrene equivalent value measured by gel permeation chromatography (GPC). When the molecular weight is within the range, the dispersibility of the polyester resin improves. The glass transition temperature of the precursor is preferably 40° C. or more, and particularly preferably from 50° C. to 80° C. When the glass transition temperature is 40° C. or more, the storage stability of the toner improves.

The polycarboxylic acid compound (H) is not particularly limited. As the polycarboxylic acid compound (H), examples include, but are not limited to, the cyclic dicarboxylic acid compound (B) such as the aromatic dicarboxylic acid compound and alicyclic dicarboxylic acid compound, the chain dicarboxylic acid compound (D) and the trivalent or higher carboxylic acid compound (F) as described above. Of them, the cyclic dicarboxylic acid compound in which a carboxyl group or a carboxylic acid derivative group is bound to each of two non-adjacent carbon atoms forming the ring, is preferred, such as terephthalic acid, tetrahydroterephthalic acid and hexahydroterephthalic acid.

The polyhydric alcohol (I) is not particularly limited. As the polyhydric alcohol (I), examples include, but are not limited to, the cyclic dihydric alcohol (C) such as the aromatic dihydric alcohol and the alicyclic dihydric alcohol, the chain dihydric alcohol (E) and the trivalent or higher alcohol (G) as described above.

The total amount of the polycarboxylic acid compound (H) or the polyhydric alcohol (I) which is used for the copolycondensation with the precursor, is preferably from 10 parts by mass to 50 parts by mass, and particularly preferably from 20 parts by mass to 40 parts by mass with respect to 100 parts by mass of the precursor. The amount of the polycarboxylic acid compound or the polyhydric alcohol is preferably within the range, since the molecular weight of the polyester resin can be increased without deteriorating the melting properties thereof.

The content of the polyester resin is preferably controlled so that the mass ratio of the styrene-acrylic resin to the polyester resin (the styrene-acrylic resin: the polyester resin) is within a range of from 96:4 to 70:30 The mass ratio is more preferably from 96:4 to 80:20, and still more preferably from 96:4 to 90:10. The mass of the styrene-acrylic resin corresponds to the mass of the polymerizable monomer.

When the content of the polyester resin is equal to or more than the lower limit value, the melt viscosity of the toner sufficiently decreases, and the fixability of the toner improves, accordingly. When the content of the polyester resin is equal to or less than the upper limit value, even in a high-temperature and high-humidity environment, the charge stability of the toner is good, resulting in the suppression of fogging and the suppression of a decrease in image quality. When the content of the polyester resin is within the above range, both the fixability of the toner and the charge stability thereof upon environmental changes can be achieved.

### (Colorant)

As the colorant contained in the polymerizable monomer composition, a colorant that is conventionally used in toners can be appropriately selected and used without particular limitation. As the colorant, a black, cyan, yellow or magenta colorant can be used.

As the black colorant, examples include, but are not limited to, carbon black, titanium black and magnetic powder such as zinc-iron oxide and nickel-iron oxide.

As the cyan colorant, examples include, but are not limited to, cyan pigments such as phthalocyanine pigments (e.g., copper phthalocyanine pigments and derivatives thereof) and anthraquinone pigments, and cyan dyes. More specifically, examples include, but are not limited to, C.I. Pigment Blue 2, 3, 6, 15, 15:1, 15:2, 15:3, 15:4, 16, 17:1 and 60, and C.I. Solvent Blue 70.

As the yellow colorant, examples include, but are not limited to, yellow pigments such as azo-based pigments (e.g., monoazo pigments and disazo pigments) and condensed polycyclic pigments, and yellow dyes. More specifically, examples include, but are not limited to, C.I. Pigment Yellow 3, 12, 13, 14, 15, 17, 62, 65, 73, 74, 83, 93, 97, 120, 138, 155, 180, 181, 185, 186, 213 and 214, and C.I. Solvent Yellow 98 and 162.

As the magenta colorant, examples include, but are not limited to, magenta pigments such as azo-based pigments (e.g., monoazo pigments and disazo pigments) and condensed polycyclic pigments, and magenta dyes. More specifically, examples include, but are not limited to, C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269; C.I. Pigment Violet 19; C.I. Solvent Red 1, 3, 8, 23, 24, 25, 27, 30, 49, 81, 82, 83, 84, 100, 109 and 121; C.I. Disperse Red 9; C.I. Solvent Violet 8, 13, 14, 21 and 27; C.I. Disperse Violet 1; C.I. Basic Red 1, 2, 9, 12, 13, 14, 15, 17, 18, 22, 23, 24, 27, 29, 32, 34, 35, 36, 37, 38, 39 and 40; and C.I. Basic Violet 1, 3, 7, 10, 14, 15, 21, 25, 26, 27 and 28.

The colorants can be used alone or in combination of two or more. From the viewpoint of improving image quality, a combination of a pigment and a dye may be used as the colorant.

In the case of using two or more kinds of pigments in combination, the two or more kinds of pigments are preferably mixed crystal pigments, since a high-quality image can be formed. As the mixed crystal pigments, examples include, but are not limited to, a mixed crystal of C.I. Pigment Violet 19 and C.I. Pigment Red 122 described below.

The black toner preferably contains carbon black as the colorant, since a high-quality image can be formed.

The cyan toner preferably contains a copper phthalocyanine pigment and a derivative thereof, since a high-quality image can be formed.

In the yellow toner, at least one selected from the group consisting of disazo pigments such as C.I. Pigment Yellow 93, 155, 180, 214 and 219 and yellow dyes such as C.I. Solvent Yellow 98 and 162, is preferably contained as the colorant, since the storage stability of the toner can be easily improved, and a high-quality image can be formed. Of them, at least one selected from the group consisting of C.I. Pigment Yellow 155, C.I. Pigment Yellow 214 and C.I. Solvent Yellow 98 is more preferably contained, and at least one selected from the group consisting of C.I. Pigment Yellow 214 and C.I. Solvent Yellow 98 is more preferably contained. Also in the yellow toner, a combination of the disazo pigment with the yellow dye is preferably contained as the colorant, since the storage stability of the toner can be easily improved, and a high-quality image can be formed. A combination of at least one selected from the group consisting of C.I. Pigment Yellow 155 and C.I. Pigment Yellow 214 with C.I. Solvent Yellow 98 is more preferred, and a combination of C.I. Pigment Yellow 214 with C.I. Solvent Yellow 98 is still more preferred.

Also in the yellow toner, the yellow pigment and yellow dye contained in the yellow colorant is preferably at a mass ratio of from 50:50 to 95:5 (yellow pigment: yellow dye), and more preferably at a mass ratio of from 60:40 to 90:10. The yellow pigment contained in the yellow colorant is preferably the disazo pigment, more preferably at least one selected from the group consisting of C.I. Pigment Yellow 155 and C.I. Pigment Yellow 214, and still more preferably C.I. Pigment Yellow 214. The yellow dye contained in the yellow colorant is preferably C.I. Solvent Yellow 98.

In the magenta toner, C.I. Pigment Red 122 is preferably contained as the colorant, since a high-quality image can be formed. Also, a combination of C.I. Pigment Red 122 and C.I. Pigment Violet 19 is more preferably used, and a mixed crystal of C.I. Pigment Violet 19 and C.I. Pigment Red 122 is particularly preferred.

The mixed crystal of C.I. Pigment Violet 19 and C.I. Pigment Red 122 can be prepared, for example, by the method described in U.S. Pat. No. 3,160,510, in which the mixed crystal components are simultaneously recrystallized from sulfuric acid or another suitable solvent, and treated with a solvent after salt grinding if necessary. The mixed crystal of C.I. Pigment Violet 19 and C.I. Pigment Red 122 can be also prepared, for example, by the method described in German Pat. No. 1217333, in which the substituted diaminoterephthalic acid mixture is treated with a solvent after cyclization.

When the magenta toner contains C.I. Pigment Violet 19 and C.I. Pigment Red 122 as the colorant, the mass ratio of C.I. Pigment Violet 19 to C.I. Pigment Red 122 is preferably from 80:20 to 20:80, more preferably from 70:30 to 30:70, and still more preferably from 60:40 to 40:60.

The content of the colorant is appropriately adjusted according to the type of the colorant so that the desired color development is obtained. The content of the colorant is not particularly limited. The content of the colorant is preferably 1 part by mass or more and 20 parts by mass or less, and more preferably 5 parts by mass or more and 15 parts by mass or less, with respect to 100 parts by mass of the styrene-acrylic resin contained as the binder resin.

### (Release Agent)

As the release agent, an ester wax is used. The ester wax is preferably a synthetic ester wax obtained by esterification of an alcohol and a carboxylic acid, and a polyfunctional ester wax or a monoester wax is preferably used. As the alcohol and carboxylic acid used for the synthesis of the ester wax, one alcohol or a combination of two or more alcohols can be used, and one carboxylic acid or a combination of two or more carboxylic acids can be used.

As the ester wax, a long-chain fatty acid ester wax obtained by use of a long-chain fatty acid containing 10 or more carbon atoms as a raw material, is also preferred. Since the effect of improving dispersibility of the long-chain fatty acid ester wax by the aid of the styrene-based thermoplastic elastomer is high, the low temperature fixability of the toner can be especially improved when used in combination with the styrene-based thermoplastic elastomer.

The polyfunctional ester wax is preferably a polyfunctional ester compound of a polyhydric alcohol and a fatty acid containing 10 to 22 carbon atoms. The number of the carbon atoms contained in the fatty acid used in the polyfunctional ester compound, is more preferably from 14 to 22, and still more preferably from 16 to 22.

The fatty acid may be a saturated or unsaturated fatty acid, and it is preferably a saturated fatty acid due to its high stability. Also, the fatty acid may be a monocarboxylic or polycarboxylic acid, and it is preferably a monocarboxylic acid. As the monocarboxylic acid, for example, lauric acid, myristic acid, palmitic acid, stearic acid, arachidic acid, behenic acid, oleic acid or the like is preferably used, and stearic acid, arachidic acid or behenic acid is particularly preferably used.

As the polyhydric alcohol used in the polyfunctional ester wax, examples include, but are not limited to, the following: a dihydric alcohol such as ethylene glycol, diethylene glycol, triethylene glycol, propylene glycol, dipropylene glycol, 1,3-propanediol, 2,4-dimethyl-2-ethylhexane-1,3-diol, 2-methyl-1,3-propanediol, 2,2-dimethyl-1,3-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 3-methyl-1,5-pentanediol and 2,2,4-trimethyl-1,6-hexanediol; a trihydric alcohol such as glycerol, trimethylolethane and trimethylolpropane; a tetrahydric alcohol such as pentaerythritol, erythritol and diglycerin; a pentahydric alcohol such as xylitol and triglycerol; a hexahydric alcohol such as sorbitol and dipentaerythritol; and an octahydric alcohol such as hexaglycerol. Of them, tetrahydric to octahydric alcohols are preferred.

As the polyfunctional ester wax, at least one selected from the group consisting of a pentaerythritol ester compound, a glycerin ester compound and a dipentaerythritol ester compound is also preferably used. As the preferred polyfunctional ester wax, examples include, but are not limited to, a pentaerythritol ester compound such as pentaerythritol tetrapalmitate, pentaerythritol tetrabehenate and pentaerythritol tetrastearate; a glycerin ester compound such as hexaglycerin tetrabehenate tetrapalmitate, hexaglycerin octabehenate, pentaglycerin heptabehenate, tetraglycerin hexabehenate, triglycerin pentabehenate, diglycerin tetrabehenate and glycerin tribehenate; and a dipentaerythritol ester compound such as dipentaerythritol hexamyristate and dipentaerythritol hexapalmitate. Of them, a glycerin ester compound is preferably used since the low temperature fixability of the toner can be especially improved when used in combination with the styrene-based thermoplastic elastomer, due to the high effect of improving dispersibility of the glycerin ester compound by the aid of the styrene-based thermoplastic elastomer.

The monoester wax is preferably a monoester compound of a monocarboxylic acid containing 10 to 22 carbon atoms and a monohydric alcohol containing 10 to 22 carbon atoms. The number of the carbon atoms of the monocarboxylic acid is more preferably from 14 to 22, and still more preferably from 16 to 22. The number of the carbon atoms of the monohydric alcohol is more preferably from 14 to 22, and still more preferably from 16 to 22.

As the preferably used monocarboxylic acid, examples include, but are not limited to, lauric acid, myristic acid, palmitic acid, stearic acid, arachidic acid (eicosanoic acid), behenic acid and oleic acid. Of them, palmitic acid, stearic acid, arachidic acid and behenic acid are preferred.

As the preferably used monohydric alcohol, examples include, but are not limited to, lauryl alcohol, myristyl alcohol, palmityl alcohol (1-hexadecanol), stearyl alcohol, arachidyl alcohol (eicosyl alcohol), behenyl alcohol and oleyl alcohol. Of them, palmityl alcohol, stearyl alcohol, arachidyl alcohol and behenyl alcohol are preferred.

The monoester wax is not particularly limited. From the viewpoint of improving the balance between the storage stability and low temperature fixability of the toner, behenyl palmitate, behenyl stearate, behenyl eicosanoate, behenyl behenate, eicosyl palmitate, eicosyl stearate, eicosyl eicosanoate, eicosyl behenate, stearyl stearate, stearyl eicosanoate, stearyl behenate, hexadecyl eicosanoate, hexadecyl behenate or the like is preferably used. Of them, behenyl stearate, behenyl palmitate and stearyl behenate are particularly preferred.

The molecular weight of the ester wax is preferably within a range of 400 or more and 3500 or less, and more preferably within a range of 500 or more and 3000 or less. When the molecular weight of the ester wax is equal to or more than the lower limit value, bleeding out of the ester wax can be suppressed, and the generation of UFP derived from the ester wax can be suppressed. When the molecular weight of the ester wax is equal to or less than the upper limit value, the low temperature fixability of the toner can be improved.

From the viewpoint of improving the balance between the storage stability and low temperature fixability of the toner, the melting point of the release agent is preferably within a range of 50° C. or more and 90° C. or less, more preferably within a range of 60° C. or more and 85° C. or less, and still more preferably within a range of 65° C. or more and 80° C. or less.

To the extent that does not impair the effects of the present disclosure, the toner of the present disclosure may further contain a release agent other than the ester wax. As the release agent other than ester wax, examples include, but are not limited to, those generally used as release agents for toners. More specifically, as the release agent other than the ester wax, examples include, but are not limited to, a hydrocarbon wax such as a polyolefin wax (e.g., polyethylene wax and polypropylene wax), a synthetic wax (e.g., Fischer-Tropsch wax) and a petroleum wax (e.g., paraffin wax, microcrystalline wax and petrolatum); a natural wax such as candelilla wax, carnauba wax, rice wax, Japan wax and jojoba wax; and a mineral wax such as montan, ceresin and ozokerite.

When the release agent other than the ester wax is contained, with respect to the total amount (100% by mass) of the release agents, the content of the ester wax is preferably 80% by mass or more, more preferably 90% by mass or more, still more preferably 95% by mass or more, and even more preferably 99% by mass or more. When the content of the ester wax is equal to or more than the lower limit value, a decrease in the toner performance can be sufficiently suppressed. More specifically, the following can be sufficiently suppressed: a deterioration in the balance between the storage stability and low temperature fixability of the toner, fogging, gloss unevenness, bleeding of the release agent, and so on.

From the viewpoint of improving the balance between the storage stability and low temperature fixability of the toner, the content of the glycerin ester compound is preferably 50% by mass, more preferably 70% by mass or more, and still more preferably 80% by mass or more of 100% by mass of the release agent.

Also, from the viewpoint of improving the balance between the storage stability and low temperature fixability of the toner, the glycerin ester compound is preferably a polyglycerol ester compound such as hexaglycerin tetrabehenate tetrapalmitate, hexaglycerin octabehenate, pentaglycerin heptabehenate, tetraglycerin hexabehenate and triglycerin pentabehenate. The polyglycerol used in the polyglycerol ester compound is a polyglycerol obtained by dehydration condensation of glycerol, and it preferably has a polymerization degree of from 3 to 9.

The content of the release agent is not particularly limited. From the viewpoint of improving the balance between the storage stability and low temperature fixability of the toner and from the viewpoint of suppression of fogging, with respect to 100 parts by mass of the styrene-acrylic resin contained as the binder resin, the content of the release agent is preferably 1 part by mass or more and 30 parts by mass or less, more preferably 5 parts by mass or more and 20 parts by mass or less, and still more preferably 10 parts by mass or more and 15 parts by mass or less.

As the release agent, one release agent may be used alone, or a combination of two or more release agents may be used.

### (Release Agent Disperser)

As the release agent disperser, a nonionic surfactant is used.

The nonionic surfactant is not particularly limited. As the nonionic surfactant, examples include, but are not limited to, a polyoxyalkylene alkyl aryl ether surfactant, a polyoxyalkylene distyrenated aryl ether surfactant, a polyoxyalkylene alkyl ether surfactant, a polyoxyalkylene alkenyl ether surfactant, a polyoxyalkylene fatty acid ester surfactant, a sorbitan fatty acid ester surfactant, a silicone-based surfactant, an acetylenic alcohol-based surfactant and a fluorine-containing surfactant.

As the polyoxyalkylene alkyl aryl ether surfactant, examples include, but are not limited to, a polyoxyethylene nonyl phenyl ether, a polyoxyethylene octyl phenyl ether and a polyoxyethylene dodecyl phenyl ether.

As the polyoxyalkylene distyrenated aryl ether surfactant, examples include, but are not limited to, a polyoxyethylene distyrenated phenyl ether.

As the polyoxyalkylene alkyl ether surfactant, examples include, but are not limited to, a polyoxyethylene lauryl ether, a polyoxyethylene cetyl ether and a polyoxyethylene stearyl ether.

As the polyoxyalkylene alkenyl ether surfactant, examples include, but are not limited to, a polyoxyethylene oleyl ether and a polyoxyethylene methylbutenyl ether.

As the polyoxyalkylene fatty acid ester surfactant, examples include, but are not limited to, a polyoxyethylene oleic acid ester, a polyoxyethylene lauric acid ester and a polyoxyethylene distearic acid ester.

The examples provided above as the nonionic surfactant which contains a polyoxyalkylene group, are typical examples and they are those in which the polyoxyalkylene group is a polyoxyethylene group. However, the nonionic surfactant is not limited to them. In the present disclosure, the nonionic surfactant which contains a polyoxyalkylene group and in which a part or all of the polyoxyethylene group is substituted with another polyoxyalkylene group such as a polyoxypropylene or polyoxybutylene group, may be used.

As the sorbitan fatty acid ester surfactant, examples include, but are not limited to, sorbitan laurate, sorbitan monostearate, sorbitan monooleate, sorbitan sesquioleate, polyoxyethylene monooleate and polyoxyethylene stearate.

As the silicone-based surfactant, examples include, but are not limited to, dimethylpolysiloxane.

As the acetylenic alcohol-based surfactant, examples include, but are not limited to, 2,4,7,9-tetramethyl-5-decyne-4,7-diol, 3,6-dimethyl-4-octyne-3,6-diol and 3,5-dimethyl-1-hexyne-3-ol.

As the fluorine-containing surfactant, examples include, but are not limited to, a fluorine alkyl ester.

As the nonionic surfactant, examples also include, but are not limited to, a polyethylene glycol fatty acid ester, a polyethylene glycol phosphoric acid ester, a fatty acid monoglyceride, a polyglycerol fatty acid ester, a propylene glycol fatty acid ester, a sucrose fatty acid ester, a polyoxyethylene-polyoxypropylene block copolymer, a polyoxyethylene-polyoxypropylene alkyl ether, an ethylene oxide derivative of an alkylphenol formalin condensate, a polyoxyethylene glycerol fatty acid ester, polyoxyethylene hydrogenated castor oil, a polyoxyethylene sorbitan fatty acid ester, a fatty acid alkanolamide and a polyoxyethylene fatty acid amide.

Of the nonionic surfactants described above, the polyoxyalkylene alkyl aryl ether surfactant, the polyoxyalkylene distyrenated aryl ether surfactant, the polyoxyalkylene alkyl ether surfactant, the polyoxyalkylene alkenyl ether surfactant and the polyoxyalkylene fatty acid ester surfactant are preferred; the polyoxyalkylene alkyl aryl ether surfactant and the polyoxyalkylene distyrenated aryl ether surfactant are more preferred; and the polyoxyalkylene distyrenated aryl ether surfactant is particularly preferred.

The nonionic surfactant is preferably the nonionic surfactant which contains a polyoxyalkylene group, since an excellent effect of improving the dispersibility of the ester wax is obtained. The repeating number of the polyoxyalkylene group is preferably from 10 to 20, and more preferably from 12 to 18. As the polyoxyalkylene group, examples include, but are not limited to, a polyoxyethylene group, a polyoxypropylene group and a polyoxybutylene group. Of them, a polyoxyethylene group is particularly preferred.

As the nonionic surfactant which contains a polyoxyalkylene group, examples include, but are not limited to, a polyoxyalkylene alkyl aryl ether surfactant, a polyoxyalkylene alkyl ether surfactant, a polyoxyalkylene alkenyl ether surfactant, polyoxyalkylene distyrenated aryl ether surfactant and a polyoxyalkylene fatty acid ester surfactant.

As the nonionic surfactant, a commercially-available product may be used. As the commercially-available product, examples include, but are not limited to, EMULGEN A-60 (product name, a polyoxyethylene (distyrenated phenyl)ether, the average number of moles of polyoxyethylene added: 13), EMULGEN 120 (product name, a polyoxyethylene lauryl ether), EMULGEN 109P (product name, a polyoxyethylene lauryl ether), EMULGEN 106 (a polyoxyethylene lauryl ether), EMULGEN 150 (a polyoxyethylene lauryl ether), EMULGEN 108 (a polyoxyethylene lauryl ether) and LATEMUL PD (product name) SERIES (polyoxyalkylene alkenyl ethers each containing an alkenyl group having a terminal double bond, a butylene oxide group and an ethylene oxide group), all of which are products manufactured by Kao Corporation, and POLYOXYETHYLENE(20) CETYL ETHER (product name, manufactured by FUJIFILM Wako Pure Chemical Corporation).

To the extent that does not impair the effects of the present disclosure, as the release agent disperser, a cationic, anionic or ampholytic ionic surfactant may be further contained. From the viewpoint of suppression of fogging by suppressing a decrease in the charge stability of the toner, from the viewpoint of suppressing a decrease in the storage stability of the toner, and from the viewpoint of suppressing the generation of gloss unevenness on a formed image, the content of the ionic surfactant contained in the polymerizable monomer composition is preferably 60% by mass or less, more preferably 50% by mass or less, still more preferably 10% by mass or less, even more preferably 5% by mass or less, and particularly preferably 1% by mass or less, with respect to the total amount (100% by mass) of the surfactant. That is, the content of the nonionic surfactant contained in the polymerizable monomer composition is preferably 40% by mass or more, more preferably 50% by mass or more, still more preferably 90% by mass or more, even more preferably 95% by mass or more, and particularly preferably 99% by mass or more, with respect to the total amount (100% by mass) of the surfactant.

The molecular weight of the surfactant used as the release agent disperser is preferably from 100 to 500, from the viewpoint of excellent release agent dispersibility.

The content of the release agent disperser is not particularly limited. With respect to 100 parts by mass of the release agent, the content of the release agent disperser is preferably from 0.1 parts by mass to 20 parts by mass, more preferably from 0.5 parts by mass to 15 parts by mass, and still more preferably from 0.7 parts by mass to 13 parts by mass. The content of the nonionic surfactant is not particularly limited. With respect to 100 parts by mass of the release agent, the content of the nonionic surfactant is preferably from 0.1 parts by mass to 20 parts by mass, more preferably from 0.4 parts by mass to 15 parts by mass, and still more preferably from 0.7 parts by mass to 12 parts by mass. Accordingly, the mass of the nonionic surfactant present on the surface of the toner particles was likely to be within a range of from 0.1 ppm to 500 ppm, with respect to the mass of the toner particles.

### (Charge Control Agent)

The charge control agent contained in the polymerizable monomer composition is not particularly limited, and a positively-chargeable charge control agent that is generally used to improve toner chargeability can be appropriately selected and used as the charge control agent.

As the positively-chargeable charge control agent, examples include, but are not limited to, a charge control compound such as a nigrosine dye, a quaternary ammonium salt, a triaminotriphenylmethane compound and an imidazole compound, and a positively-chargeable charge control resin.

As the charge control agent, a positively-chargeable charge control resin is preferably contained from the following points of view: it has high compatibility with the polymerizable monomer; it can impart stable chargeability to the toner particles; and it has excellent charge stability.

As the positively-chargeable charge control resin, a functional group-containing copolymer can be used. More specifically, a functional group-containing copolymer which contains a constitutional unit in which a functional group such as an amino group, a quaternary ammonium group and a quaternary ammonium salt-containing group is contained, can be used.

In the functional group-containing copolymer used as the positively-chargeable charge control resin, the content of the functional group-containing constitutional unit (in the present disclosure, it may be simply referred to as “functional group amount”) with respect to all the constitutional units is preferably 0.3% by mass or more and 20% by mass or less, and more preferably 0.3% by mass or more and 10% by mass or less. When the functional group amount is equal to or more than the lower limit value, the chargeability of the toner improves, and fogging is less likely to occur. When the functional group amount is equal to or less than the upper limit value, the balance between the low temperature fixability and heat-resistant storage stability of the toner is likely to improve. When the functional group amount is too large, the charge stability deteriorates, and fogging is likely to occur, accordingly. However, when the functional group amount is equal to or less than the upper limit value, fogging is less likely to occur.

As the functional group-containing copolymer, two or more functional group-containing copolymers having different functional group amounts, may be contained in combination. When the colored resin particles contain, as the charge control resin, two or more functional group-containing copolymers having different functional group amounts in combination, the dispersibility of the colorant can be improved while imparting the desired chargeability to the toner. As a result, the colorant can be contained at high concentration, and the image density can be improved, accordingly. When the copolymer A having a relatively large functional group amount is used in combination with the copolymer B having a relatively small functional group amount, due to the difference in the functional group amount, the toner is considered to have such a copolymer distribution, that the copolymer B is unevenly distributed on the relatively center side of the colored resin particles and the copolymer A is unevenly distributed on the more surface side of the colored resin particles. Since the copolymer A has a larger functional group amount than the copolymer B, it has a high charging effect and is unevenly distributed on the more surface side of the colored resin particles. Accordingly, the chargeability of the toner is thought to be mainly subject to the influence of the copolymer A. Meanwhile, the copolymer B is thought to be highly effective in dispersing the colorant in the interior of the colored resin particles, while exerting a charging effect. It is presumed that by the action of such copolymers A and B, the desired chargeability is imparted to the toner, and the dispersibility of the colorant is improved.

When two or more functional group-containing copolymers having different functional group amounts are contained as the charge control agent, a copolymer A having a functional group amount of 5% by mass or more and 10% by mass or less and a copolymer B having a functional group amount of 0.3% by mass or more and less than 5% by mass are preferably contained.

From the viewpoint of imparting the desired chargeability to the toner and improving the dispersibility of the colorant, the functional group amount of the copolymer A is preferably 5% by mass or more, and more preferably 6% by mass or more as the lower limit, and it is preferably 10% by mass or less, and more preferably 9% by mass or less as the upper limit.

From the viewpoint of imparting the desired chargeability to the toner and improving the dispersibility of the colorant, the functional group amount of the copolymer B is preferably 0.3% by mass or more, and more preferably 0.5% by mass or more as the lower limit, and it is preferably less than 5% by mass, more preferably 4% by mass or less, and still more preferably 3% by mass or less as the upper limit.

Meanwhile, when one functional group-containing copolymer is used alone, the functional group amount of the functional group-containing copolymer is preferably 0.3% by mass or more, and more preferably 0.5% by mass or more as the lower limit, and it is preferably 20% by mass or less, more preferably 10% by mass or less, still more preferably 3% by mass or less, even more preferably 2.5% by mass or less, and particularly preferably 2% by mass or less as the upper limit.

From the viewpoint of high compatibility with the polymerizable monomer, the functional group-containing copolymer used as the positively-chargeable charge control resin is preferably a styrene-acrylic resin. The styrene-acrylic resin is preferably a copolymer of two or more monomers including an aromatic vinyl monomer and a (meth)acrylate monomer. The total of a constitutional unit derived from the aromatic vinyl monomer and a constitutional unit derived from the (meth)acrylate monomer is preferably 50% by mass or more, more preferably 70% by mass or more, and still more preferably 90% by mass or more with respect to all the constitutional units.

The glass transition temperature (Tg) of the charge control resin is preferably within a range of 50° C. or more and 110° C. or less, and more preferably within a range of 60° C. or more and 100° C. or less. When the glass transition temperature (Tg) of the charge control resin is within the above range, the balance between the low temperature fixability and heat-resistant storage stability of the toner is likely to improve.

The weight average molecular weight Mw of the charge control resin is preferably in a range of 5000 or more and 30000 or less, and more preferably in a range of from 10000 or more and 25000 or less. When the weight average molecular weight Mw of the charge control resin is within the range, the balance between the low temperature fixability and heat-resistant storage stability of the toner is likely to improve.

The content of the charge control agent is not particularly limited. With respect to 100 parts by mass of the styrene-acrylic resin contained as the binder resin, the content of the charge control agent is preferably 0.01 parts by mass or more and 15 parts by mass or less, and more preferably 0.03 parts by mass or more and 8 parts by mass or less. When the content of the charge control agent is equal to or more than the lower limit value, fogging can be suppressed. On the other hand, when the content is equal to or less than the upper limit value, print soiling can be suppressed.

As the charge control agent, one charge control agent can be used alone, or a combination of two or more charge control agents can be used.

### (Acidic Group-Containing Acrylic Resin)

The polymerizable monomer composition may contain an acidic group-containing acrylic resin. Accordingly, the particle diameter of the colored resin particles can be easily controlled, and the formation of coarse particles can be suppressed.

The acidic group-containing acrylic resin is preferably a copolymer of at least one selected from the group consisting of an acrylic acid ester and a methacrylic acid ester and at least one selected from the group consisting of acrylic acid and methacrylic acid, and it is more preferably a copolymer of an acrylic acid ester, a methacrylic acid ester and an acrylic acid.

As the (meth)acrylic acid ester, examples include, but are not limited to, alkyl (meth)acrylate such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, sec-pentyl (meth)acrylate, isopentyl (meth)acrylate, neopentyl (meth)acrylate, n-hexyl (meth)acrylate, isohexyl (meth)acrylate, neohexyl (meth)acrylate, sec-hexyl (meth)acrylate, tert-hexyl (meth)acrylate, 2-ethylhexyl (meth)acrylate and lauryl (meth)acrylate. Examples also include, but are not limited to, 2-hydroxyethyl (meth)acrylate, 2-hydroxypropyl (meth)acrylate, 4-hydroxybutyl (meth)acrylate, methoxypolyethylene glycol (meth)acrylate, dimethylaminoethyl (meth)acrylate, diethylaminoethyl (meth)acrylate, glycidyl (meth)acrylate and 4-hydroxybutyl acrylate glycidyl ether. Of them, alkyl (meth)acrylate is preferred.

As the acrylic acid ester used in the acidic group-containing acrylic resin is preferably at least one selected from the group consisting of ethyl acrylate, n-propyl acrylate, isopropyl acrylate and n-butyl acrylate, and it is more preferably at least one selected from the group consisting of ethyl acrylate and n-butyl methacrylate. The methacrylic acid ester used in the acidic group-containing acrylic resin is preferably at least one selected from the group consisting of methyl methacrylate, n-propyl methacrylate, isopropyl methacrylate and n-butyl methacrylate, and particularly preferably methyl methacrylate.

In the acidic group-containing acrylic resin, the amount of (meth)acrylic acid with respect to the total amount (100% by mass) of the (meth)acrylic acid ester and (meth)acrylic acid used for the synthesis of the acidic group-containing acrylic resin, is preferably from 0.05% by mass to 1% by mass, more preferably from 0.1% by mass to 0.6% by mass, and still more preferably from 0.3% by mass to 0.5% by mass, from the viewpoint of high compatibility with the polymerizable monomer, from the point of view that the particle diameter of the colored resin particles can be easily controlled, and from the point of view that the formation of coarse particles can be easily suppressed.

The acidic group-containing acrylic resin is preferably a copolymer of a monomer which contains 50.0% by mass or more of methyl methacrylate with respect to the total mass (100% by mass) of the monomer used for the synthesis of the copolymer, from the viewpoint of high compatibility with the polymerizable monomer, from the point of view that the particle diameter of the colored resin particles can be easily controlled, and from the point of view that the formation of coarse particles can be easily suppressed. The acidic group-containing acrylic resin is more preferably a copolymer of a monomer which contains 50.0% by mass to 99.9% by mass of methyl methacrylate and 0.1% by mass to 5.0% by mass of (meth)acrylic acid, still more preferably a copolymer of a monomer which contains 50.0% by mass to 99.0% by mass of methyl methacrylate and 0.1% by mass to 5.0% by mass of (meth)acrylic acid, even more preferably a copolymer of a monomer which contains 50.0% by mass to 98.0% by mass of methyl methacrylate, 1.0% by mass to 5.0% by mass of alkyl (meth)acrylate different from methyl methacrylate, and 0.1% by mass to 5.0% by mass of (meth)acrylic acid, and particularly preferably a copolymer of a monomer which contains 50.0% by mass to 98.0% by mass of methyl methacrylate, 1.0% by mass to 5.0% by mass of alkyl (meth)acrylate different from methyl methacrylate, and 0.2% by mass to 3.0% by mass of (meth)acrylic acid.

The alkyl (meth)acrylate different from methyl methacrylate is preferably at least one selected from the group consisting of ethyl acrylate and butyl acrylate, from the point of view that the glass transition temperature of the copolymer can be controlled.

The acidic group-containing acrylic resin may contain a small amount of a monomer unit that is derived from a monomer that is different from both a (meth)acrylic acid ester and a (meth)acrylic acid. From the point of view that the particle diameter of the colored resin particles can be easily controlled, and from the point of view that the formation of coarse particles can be easily suppressed, the proportion of the content of the different monomer is preferably 30% by mass or less, more preferably 20% by mass or less, and still more preferably 10% by mass or less of the total amount (100% by mass) of the monomer used for the synthesis of the acidic group-containing acrylic resin. Most preferably, the acidic group-containing acrylic resin is free of the different monomer.

As the different monomer, examples include, but are not limited to, a halogenated aromatic vinyl monomer, a polar group-containing aromatic vinyl monomer, a carboxylic acid vinyl ester monomer, a halogenated vinyl monomer, a vinylidene halide monomer, vinylpyridine, an ethylenically unsaturated carboxylic acid monomer, allyl glycidyl ether, an aromatic vinyl monomer, a monoolefin monomer and a diene monomer.

The acid value of the acidic group-containing acrylic resin is preferably from 0.5 mgKOH/g to 7.0 mgKOH/g, more preferably from 1.0 mgKOH/g to 5.0 mgKOH/g, and still more preferably from 1.5 mgKOH/g to 3.0 mgKOH/g. When the acid value of the acidic group-containing acrylic resin is within the range, the effect of improving the heat-resistant storage stability, low temperature fixability and printing durability of the toner is high, and the effect of suppressing the production of coarse particles is also high.

The weight average molecular weight Mw of the acidic group-containing acrylic resin is preferably from 8,000 to 45,000, more preferably from 9,000 to 45,000, and still more preferably from 10,000 to 40,000. When the weight average molecular weight Mw of the acidic group-containing acrylic resin is equal to or more than the lower limit value, the heat-resistant storage stability and durability of the toner can be improved. When the weight average molecular weight Mw of the polar resin is equal to or less than the upper limit value, an increase in the fixing temperature of the toner can be suppressed.

The glass transition temperature (Tg) of the acidic group-containing acrylic resin is preferably from 60° C. to 95° C., more is preferably from 65° C. to 90° C., and still more is preferably from 70° C. to 80° C.

When the glass transition temperature of the acidic group-containing acrylic resin is equal to or more than the lower limit value, the heat-resistant storage stability of the toner can be improved. When the glass transition temperature is equal to or less than the upper limit value, the low temperature fixability of the toner can be improved.

A commercially-available product can be used as the acidic group-containing acrylic resin, or the acidic group-containing acrylic resin can be produced by polymerizing a monomer containing the above-described monomer by a known polymerization method such as a solution polymerization method, an aqueous solution polymerization method, an ionic polymerization method, a high-temperature and high-pressure polymerization method and a suspension polymerization method.

When the acidic group-containing acrylic resin is a copolymer, the copolymer may be any of a random copolymer, a block copolymer and a graft copolymer. The copolymer is preferably a random copolymer.

From the viewpoint of improving solubility, the acidic group-containing acrylic resin is preferably pulverized finely.

The content of the acidic group-containing acrylic resin is preferably from 0.5 parts by mass to 2.5 parts by mass, more preferably from 0.8 parts by mass to 2.2 parts by mass, and still more preferably from 1.0 part by mass to 2.0 parts by mass, with respect to 100 parts by mass of the styrene-acrylic resin contained as the binder resin. When the content of the acidic group-containing acrylic resin is equal to or more than the lower limit value, the particle diameter of the colored resin particles can be easily controlled, and the production of coarse particles can be easily suppressed. On the other hand, when the content of the acidic group-containing acrylic resin is equal to or less than the upper limit value, an increase in the fixing temperature of the toner can be suppressed.

### (Styrene-Based Thermoplastic Elastomer)

The polymerizable monomer composition may further contain the styrene-based thermoplastic elastomer. Since the styrene-based thermoplastic elastomer can improve the dispersibility of the release agent, the fixability of the toner can be improved by containing the styrene-based thermoplastic elastomer, while maintaining the heat resistant temperature of the toner. The styrene-based thermoplastic elastomer means a copolymer of a styrene-based monomer and another monomer which is copolymerizable with the styrene-based monomer and which is at least one selected from the group consisting of monoolefin, diolefin and so on, such as a random copolymer, a block copolymer and a graft copolymer, and a hydrogenated product of any of these copolymers.

As the styrene-based thermoplastic elastomer used in the present disclosure, examples include, but are not limited to, a styrene-butadiene-styrene block copolymer, a styrene-butadiene block copolymer, a styrene-isoprene-styrene block copolymer, a styrene-isoprene block copolymer, a styrene-butadiene-isoprene-styrene block copolymer and hydrogenated products thereof. Examples also include, but are not limited to, a styrene-ethylene-butylene-styrene block copolymer, a styrene-ethylene-propylene-styrene block copolymer and a styrene-ethylene-ethylene-propylene-styrene block copolymer.

Of these styrene-based thermoplastic elastomers, a styrene-isoprene-styrene block copolymer is preferably used from the viewpoint of optimizing the balance between the storage stability and low temperature fixability of the toner.

The content of the styrene unit in the styrene-based thermoplastic elastomer is preferably from 15% by mass to 70% by mass, more preferably from 15% by mass to 60% by mass, and still more preferably from 20% by mass to 40% by mass. When the styrene content is equal to or more than the lower limit value, the proportion of the hydrocarbon unit is not too high; the fixed toner is less likely to peel from the fixed surface; and a decrease in the fixability is suppressed, accordingly. On the other hand, when the styrene content is equal to or less than the upper limit value, the compatibility with the binder resin is not too high, and a decrease in the storage stability of the toner is suppressed, accordingly.

The weight average molecular weight Mw of the styrene-based thermoplastic elastomer is not particularly limited. From the viewpoint of an excellent effect of improving the fixability of the toner while keeping the heat resistant temperature thereof, the weight average molecular weight Mw is preferably from 50,000 to 350,000, and more preferably from 80,000 to 250,000.

As the styrene-based thermoplastic elastomer, a commercially-available product can be used. As the commercially-available product of the styrene-based thermoplastic elastomer, examples include, but are not limited to, QUINTAC (registered trademark) SERIES manufactured by ZEON Corporation and SEPTON (registered trademark) SERIES manufactured by Kuraray Co., Ltd.

The content of the styrene-based thermoplastic elastomer is not particularly limited. With respect to 100 parts by mass of the styrene-acrylic resin contained as the binder resin, the amount of the styrene-based thermoplastic elastomer is preferably from 0.5 parts by mass to 10 parts by mass, more preferably from 1 part by mass to 8 parts by mass, and still more preferably from 2 parts by mass to 6 parts by mass. The above styrene-based thermoplastic elastomers may be used alone or in combination of two or more.

### (Another Additive)

To the extent that does not impair the effects of the present disclosure, the polymerizable monomer composition may further contain another additive, as needed.

As another additive, for example, a molecular weight modifier is preferably used.

The molecular weight modifier is not particularly limited, as long as it is one that is generally used as a molecular weight modifier for toners. As the molecular weight modifier, examples include, but are not limited to, a mercaptan such as t-dodecyl mercaptan, n-dodecyl mercaptan, n-octyl mercaptan and 2,2,4,6,6-pentamethylheptane-4-thiol, and a thiuram disulfide such as tetramethyl thiuram disulfide, tetraethyl thiuram disulfide, tetrabutyl thiuram disulfide, N, N′-dimethyl-N,N′-diphenyl thiuram disulfide and N,N′-dioctadecyl-N,N′-diisopropyl thiuram disulfide.

These molecular weight modifiers may be used alone or in combination of two or more.

When the polymerizable monomer composition contains the molecular weight modifier, the content of the molecular weight modifier is not particularly limited, and it is appropriately controlled so that the binder resin obtains the desired molecular weight. With respect to 100 parts by mass of the monovinyl monomer, the content of the molecular weight modifier is generally 0.01 parts by mass or more and 10 parts by mass or less, and it may be 0.1 parts by mass or more and 5 parts by mass or less.

The polymerizable monomer composition may further contain a polymerization initiator. The polymerization initiator may be added to a dispersion obtained in the droplets forming step described below. Since the molecular weight of the polymer can be easily controlled, in the droplets forming step, the polymerization initiator is preferably added to a dispersion obtained by dispersing the polymerizable monomer composition in an aqueous solvent.

### (A-2) Suspension Step to Obtain Suspension (Droplets Forming Step)

Next, the polymerizable monomer composition is dispersed in an aqueous medium containing a dispersion stabilizer; a polymerization initiator is added therein; and then the polymerizable monomer composition is formed into droplets. As described above, the polymerization initiator may be added after dispersing the polymerizable monomer composition in the aqueous medium and before forming the polymerizable monomer composition into droplets, or the polymerization initiator may be added to the polymerizable monomer composition before being dispersed in the aqueous medium.

The method for forming the droplets is not particularly limited. For example, the droplets are formed by means of a device that enables strong stirring, such as an (in-line type) emulsifying and dispersing machine (product name: MILDER, manufactured by: Pacific Machinery & Engineering Co., Ltd.) and a high-speed emulsification dispersing machine (product name: T. K. HOMOMIXER MARK II, manufactured by: PRIMIX Corporation).

As the polymerization initiator, examples include, but are not limited to, a persulfate such as potassium persulfate and ammonium persulfate; an azo compound such as 4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; and an organic peroxide such as di-t-butylperoxide, benzoylperoxide, t-butylperoxy-2-ethylhexanoate, t-butylperoxy-2-ethylbutanoate, t-hexylperoxy-2-ethylbutanoate, diisopropylperoxydicarbonate, di-t-butylperoxyisophthalate and t-butylperoxyisobutyrate. Among them, the organic peroxide is preferably used since it can reduce a residual polymerizable monomer and the toner with excellent printing durability can be obtained. Among the organic peroxides, a peroxy ester is preferred, and a non-aromatic peroxy ester (i.e., a peroxy ester free of aromatic ring) is more preferred since they have good initiator efficiency and can reduce a residual polymerizable monomer.

These polymerization initiators may be used alone or in combination of two or more.

The amount of the added polymerization initiator used to initiate a polymerization reaction of the polymerizable monomer composition, is preferably from 0.1 parts by mass to 20 parts by mass, more preferably from 0.3 parts by mass to 15 parts by mass, and particularly preferably from 1 part by mass to 10 parts by mass, with respect to 100 parts by mass of the monovinyl monomer.

In the present disclosure, the aqueous medium means a medium containing water as a main component.

In the present disclosure, the dispersion stabilizer is preferably added to the aqueous medium. As the dispersion stabilizer, examples include, but are not limited to, the following inorganic and organic compounds: an inorganic compound such as a sulfate (e.g., barium sulfate and calcium sulfate), a carbonate (e.g., barium carbonate, calcium carbonate and magnesium carbonate), a phosphate (e.g., calcium phosphate), a metal oxide (e.g., aluminum oxide and titanium oxide), a metal hydroxide (e.g., aluminum hydroxide, magnesium hydroxide and iron(II) hydroxide) and silicon dioxide, and an organic compound such as a water-soluble polymer (e.g., polyvinyl alcohol, methyl cellulose and gelatin), an anionic surfactant, a nonionic surfactant and an ampholytic surfactant. These dispersion stabilizers may be used alone or in combination of two or more.

Among the above dispersion stabilizers, the inorganic compound is preferable. As the aqueous medium containing the dispersion stabilizer, a colloid of a sparingly water-soluble metal hydroxide is particularly preferable. The use of the inorganic compound, particularly the use of the colloid of the sparingly water-soluble metal hydroxide, can narrow the particle size distribution of the colored resin particles and can reduce the amount of the dispersion stabilizer remaining after washing. Accordingly, the toner thus obtained is capable of reproducing clear images and does not cause a deterioration in environmental stability.

### (A-3) Polymerization Step

After the polymerizable monomer composition is formed into droplets as described in the above (A-2), the polymerizable monomer composition is subjected to a polymerization reaction in the presence of a polymerization initiator, thereby forming colored resin particles. That is, an aqueous dispersion medium in which the droplets of the polymerizable monomer composition are dispersed, is heated to initiate polymerization, thereby preparing an aqueous dispersion of the colored resin particles.

The heating condition is not particularly limited. The heating temperature is preferably 50° C. or more, and more preferably from 60° C. to 95° C. The heating time is preferably from 1 hour to 20 hours, and more preferably from 2 hours to 15 hours.

As the toner, the colored resin particles may be used as they are, or an external additive may be added to the colored resin particles to provide the toner. The colored resin particles are preferably used as the core layer of so-called core-shell type (or “capsule type”) colored resin particles. The core-shell type colored resin particles have a structure such that the outside of the core layer is covered with a shell layer formed from a material different from the core layer. By covering the core layer, which is made of a material having a low softening point, with a material having a higher softening point, the low temperature fixability and storage stability of the toner can be improved with balance.

The method for producing the core-shell type colored resin particles by using the above-mentioned colored resin particles, is not particularly limited, and they can be produced by any conventional method. The in situ polymerization method and the phase separation method are preferable from the viewpoint of production efficiency.

Hereinafter, the method for producing the core-shell type colored resin particles according to the in situ polymerization method will be described.

The core-shell type colored resin particles can be obtained by adding a polymerizable monomer for forming a shell layer (a polymerizable monomer for shell) and a polymerization initiator to the aqueous medium in which the colored resin particles are dispersed and polymerizing the monomer.

As the polymerizable monomer for shell, the above-mentioned polymerizable monomers can be similarly used. Among the polymerizable monomers, those that can provide a polymer having a Tg of more than 80° C., such as styrene, acrylonitrile and methyl methacrylate, are preferably used alone or in combination of two or more.

As the polymerization initiator used for polymerization of the polymerizable monomer for shell, examples include, but are not limited to, a water-soluble polymerization initiator such as a metal persulfate (e.g., potassium persulfate and ammonium persulfate) and an azo-type initiator (e.g., 2,2′-azobis(2-methyl-N-(2-hydroxyethyl)propionamide) and 2,2′-azobis(2-methyl-N-(1,1-bis(hydroxymethyl)-2-hydroxyethyl)propionamide)). These polymerization initiators may be used alone or in combination of two or more. The amount of the polymerization initiator is preferably from 0.1 parts by mass to 30 parts by mass, and more preferably from 1 part by mass to 20 parts by mass, with respect to 100 parts by mass of the polymerizable monomer for shell.

The polymerization temperature of the shell layer is preferably 50° C. or more, and more preferably from 60° C. to 95° C. The polymerization reaction time is preferably from 1 hour to 20 hours, and more preferably from 2 hours to 15 hours.

### (A-4) Washing, Filtering, Dehydrating and Drying Steps

It is preferable that after the polymerization, the aqueous dispersion of the colored resin particles obtained by the polymerization is subjected to operations of washing for removal of the dispersion stabilizer, filtering, dehydrating, and drying repeatedly more than one time as needed, according to any conventional method.

The washing may be carried out as follows: when the inorganic compound is used as the dispersion stabilizer, it is preferable that the dispersion stabilizer is dissolved in water and removed by adding acid or alkali to the aqueous dispersion of the colored resin particles. When the colloid of the sparingly water-soluble inorganic hydroxide is used as the dispersion stabilizer, it is preferable that the pH of the aqueous dispersion of the colored resin particles is adjusted to 6.5 or less by adding acid. As the added acid, examples include inorganic acid such as sulfuric acid, hydrochloric acid and nitric acid, and organic acid such as formic acid and acetic acid. Among them, sulfuric acid is particularly preferable for its high removal efficiency and small impact on production facilities.

The colored resin particles are washed until the electrical conductivity of the filtrate reaches preferably 300 μS/cm or less, more preferably 200 μS/cm or less, and still more preferably 50 μS/cm or less. As a result, the electrical conductivity of a toner extract is likely to fall within a preferred range described below.

This filtrate means, among the filtrates obtained during the washing step, the filtrate just before the end of the washing step.

The dehydrating and filtering may be carried out by any of various known methods, without particular limitation. For example, a centrifugal filtration method, a vacuum filtration method and a pressure filtration method may be used. Also, the drying step may be carried out by any of various methods, without particular limitation.

### (B) Pulverization Method

In the case of producing the colored resin particles by employing the pulverization method, the production is carried out by the following steps, for example.

First, the binder resin, the colorant, the release agent, the release agent disperser, the charge control agent and another additive added as needed, such as the acidic group-containing acrylic resin and the styrene-based thermoplastic elastomer, are mixed by means of a mixer such as a ball mill, a V type mixer, FM MIXER (product name), a high-speed dissolver, an internal mixer and a Forberg mixer. Next, the thus-obtained mixture is kneaded by means of a press kneader, a twin screw kneading machine, a roller or the like, while heating the mixture. The thus-obtained kneaded product is coarsely pulverized by means of a pulverizer such as a hammer mill, a cutter mill and a roller mill. The coarsely pulverized product is finely pulverized by means of a pulverizer such as a jet mill and a high-speed rotary pulverizer. Then, the finely pulverized product is classified into the desired particle diameters by means of a classifier such as an air classifier and an airflow classifier, thereby obtaining colored resin particles produced by the pulverization method.

As the binder resin, the colorant, the release agent, the release agent disperser and the charge control agent, and as the acidic group-containing acrylic resin and the styrene-based thermoplastic elastomer, which are added as needed, those mentioned above in “(A) Suspension polymerization method” can be used in the pulverization method. The core-shell type colored resin particles can be produced by using the colored resin particles obtained by the pulverization method in the in situ polymerization method, etc., as with the colored resin particles obtained by the “(A) Suspension polymerization method” described above.

### 2. Colored Resin Particles

The colored resin particles contained in the toner of the present disclosure are obtained by the above production method such as (A) Suspension polymerization method or (B) Pulverization method.

Hereinafter, the colored resin particles contained in the toner will be described. The colored resin particles described below encompass both core-shell type colored resin particles and non-core-shell type colored resin particles.

The colored resin particles contained in the toner of the present disclosure contain a binder resin, a colorant, a release agent, a release agent disperser and a charge control agent. As needed, they may further contain another additive such as an acidic group-containing acrylic resin and a styrene-based thermoplastic elastomer.

As the binder resin, at least the following are contained: the above-described styrene-acrylic resin obtained by the polymerization of the polymerizable monomer used in the above-described “(A) Suspension polymerization method”, and the above-described polyester resin. In the toner of the present disclosure, the styrene-acrylic resin and polyester resin contained as the binder resin are not crosslinked by covalent bonding, and a relatively weak force such as n-n interaction and hydrogen bonding works between the resins. Accordingly, both the low temperature fixability and the hot offset resistance, which generally have a trade-off relationship, can be achieved. The acid value of the styrene-acrylic resin contained as the binder resin is generally less than 0.5 mgKOH/g, and it may be 0 mgKOH/g.

In addition to the above-described styrene-acrylic resin and polyester resin, as the binder resin, a resin which is widely and conventionally used in toners, such as polystyrene resin and epoxy resin, can be used in the toner of the present disclosure, to the extent that does not impair the effects of the present disclosure.

In the toner of the present disclosure, with respect to 100% by mass of the binder resin, the total amount of the styrene-acrylic resin and the polyester resin is preferably 90% by mass or more, more preferably 95% by mass or more, still more preferably 99% by mass or more, and particularly preferably 100% by mass.

The colorant, release agent, release agent disperser, charge control agent, acidic group-containing acrylic resin and styrene-based thermoplastic elastomer contained in the colored resin particles are as described above in “(A) Suspension polymerization method”.

### 3. External Additive

As the toner of the present disclosure, the colored resin particles can be used as they are. From the viewpoint of controlling the chargeability, flowability and storage stability of the toner, an external additive may be added on the surface of the colored resin particles to provide the toner of the present disclosure, by carrying out an external addition treatment for mixing and stirring the colored resin particles with the external additive.

A mixer used for the external addition treatment is not particularly limited, as long as it is a mixer capable of adding the external additive on the surface of the colored resin particles. For example, the external addition treatment can be carried out by means of a mixer capable of mixing and stirring, such as FM MIXER (: product name, manufactured by NIPPON COKE & ENGINEERING CO., LTD.), SUPER MIXER (: product name, manufactured by KAWATA Manufacturing Co., Ltd.), Q MIXER (: product name, manufactured by NIPPON COKE & ENGINEERING CO., LTD.), MECHANOFUSION SYSTEM (: product name, manufactured by Hosokawa Micron Corporation) and MECHANOMILL (: product name, manufactured by Okada Seiko Co., Ltd.)

As the external additive, examples include, but are not limited to, inorganic fine particles of silica, titanium oxide, aluminum oxide, zinc oxide, tin oxide, calcium carbonate, calcium phosphate, cerium oxide, barium titanate, strontium titanate or the like, and organic fine particles of polymethyl methacrylate resin, silicone resin, melamine resin or the like. Among them, inorganic fine particles are preferred. Among inorganic fine particles, at least one kind of fine particles selected from the group consisting of silica fine particles and titanium oxide fine particles are preferred, and silica fine particles are particularly preferred.

These external additives may be used alone, and they are preferably used in combination of two or more.

In the toner of the present disclosure, the amount of the external additive used is generally from 0.05 parts by mass to 6 parts by mass, and preferably from 0.2 parts by mass to 5 parts by mass, with respect to 100 parts by mass of the colored resin particles. When the content of the external additive is 0.05 parts by mass or more, the production of a transfer residue can be suppressed. When the content is 6 parts by mass or less, fogging can be suppressed.

### 4. Toner Particles

The toner of the present disclosure is a group of the “toner particles”. The toner particles may consist of the colored resin particles only, or they may contain the colored resin particles and an external additive added to the surface of the colored resin particles.

In the toner of the present disclosure, with respect to the mass of the toner particles, the mass of the nonionic surfactant present on the surface of the toner particles is from 0.1 ppm to 500 ppm, and it is preferably from 30 ppm to 500 ppm. The mass of the nonionic surfactant present on the surface of the toner particles serves as an index of the amount of the nonionic surfactant added as the release agent disperser in the production of the colored resin particles. The lower limit of the mass of the nonionic surfactant present on the surface of the toner particles is only required to be 0.1 ppm or more, and it is preferably 20 ppm or more, more preferably 30 ppm or more, and still more preferably 40 ppm or more. When the mass of the nonionic surfactant present on the surface of the toner particles is equal to or more than the lower limit value, the amount of the added nonionic surfactant is sufficient, and the dispersibility of the release agent is excellent. Accordingly, the melt viscosity of the toner decreases, and the low temperature fixability of the toner improves. On the other hand, when the mass of the nonionic surfactant present on the surface of the toner particles is 500 ppm or less, a deterioration in the toner properties caused by the surfactant present on the surface of the toner particles, is suppressed. More specifically, a deterioration in the charge stability is suppressed, and fogging is less likely to occur, accordingly. In addition, since blocking is suppressed, the heat-resistant storage stability is excellent. In addition, bleeding of the release agent is suppressed. The mass of the nonionic surfactant present on the surface of the toner particles is preferably less than 400 ppm, more preferably less than 300 ppm, still more preferably less than 200 ppm, even more preferably less than 100 ppm, and particularly preferably less than 90 ppm.

The mass of the surfactant present on the surface of the toner particles can be measured by use of the toner extract. The toner extract means a liquid obtained by adding the toner to an aqueous medium, stirring them, and extracting an aqueous component present on the surface of the toner particles into the aqueous medium. As the aqueous medium, a mixed solvent of alcohol and water is preferably used.

More specifically, the toner extract used to measure the mass of the surfactant present on the surface of the toner particles, is obtained by dispersing 10 g of the toner in 100 mL a mixed solvent of isopropyl alcohol (IPA) and deionized water (IPA/deionized water=80/20 (volume ratio)), stirring them at 50° C. for 30 minutes, and then separating the liquid component from the mixture.

When the toner extract contains the nonionic surfactant and the ionic surfactant, the mass of the nonionic surfactant only can be measured as follows. First, the toner extract is treated with an anion-exchange resin and a cation-exchange resin to remove the ionic surfactant from the toner extract. Then, the amount of the surfactant is measured from the residual extract.

The mass of the surfactant contained in the toner extract can be measured by a method which is, depending on the type of the surfactant, appropriately selected from known methods such as the liquid chromatography mass spectrometry analysis (LC/MS), the ion-exchange chromatography analysis (IC) and the gas chromatography mass spectrometry analysis (GC/MS).

The mass of the nonionic surfactant used in the present disclosure can be measured by the liquid chromatography mass spectrometry analysis (LC/MS). Details of the measurement method by LC/MS are as described below under “Examples”.

From the viewpoint of suppression of fogging by suppressing a decrease in the charge stability of the toner, from the viewpoint of suppressing a decrease in the storage stability of the toner, and from the viewpoint of suppressing the generation of gloss unevenness on a formed image, the mass of the ionic surfactant present on the surface of the toner particles is preferably 40 ppm or less, more preferably 30 ppm or less, still more preferably 20 ppm or less, even more preferably 10 ppm or less, and particularly preferably 1 ppm or less.

In the toner of the present disclosure, the volume average particle diameter (Dv) of the toner particles is preferably from 3 μm to 15 μm, and more preferably from 4 μm to 12 μm. When the volume average particle diameter (Dv) is equal to or more than the lower limit value, the flowability of the toner can be improved, and a deterioration in transferability and a decrease in image density can be suppressed. When the volume average particle diameter (Dv) is equal to or less than the upper limit value, a decrease in image resolution can be suppressed.

The particle size distribution (Dv/Dp) which is the ratio of the volume average particle diameter (Dv) to number average particle diameter (Dp) of the toner particles, is preferably 1.0 or more and less than 1.3, and more preferably 1.0 or more and 1.2 or less. When the Dv/Dp ratio is less than 1.3, a decrease in transferability, image density and resolution can be suppressed.

The volume average particle diameter and number average particle diameter of the toner particles can be measured by means of a particle size distribution analyzer (product name: MULTISIZER; manufactured by: Beckman Coulter, Inc.), for example.

The average circularity of the toner particles is preferably from 0.96 to 1.00, more preferably from 0.97 to 1.00, and still more preferably from 0.98 to 1.00, from the viewpoint of image reproducibility.

When the average circularity of the toner particles is equal to or more than the lower limit value, fine line reproducibility of printing can be improved. The average circularity of the toner particles is 1 or less. When the measurement sample of the toner particles is perfectly spherical, the average circularity is 1.

In the present disclosure, the “circularity” is defined as a value obtained by dividing the perimeter of the circle having the same area as the projected area of the particle image by the perimeter of the projected image of the particle. The average circularity is an index that shows the degree of the surface roughness of the toner particles, and it can be used as a simple method for quantitatively representing the shape of the particles. The average circularity decreases as the surface shape of the measurement sample becomes more complex.

For example, the circularity of the toner particles can be determined as follows. An aqueous solution in which the toner particles are dispersed, is used as a sample solution, and the projected image of the toner particles in the sample solution is taken by means of a flow type particle image analyzer (e.g., product name: FPIA-2100, manufactured by: Sysmex Corporation). The perimeter of a circle having the same area as the projected area of the particle image, and the perimeter of the projected particle image are measured from the projected image, and the circularity of the toner particles is obtained by the following calculation formula 1. The average circularity is the average value of the circularities of the toner particles contained in the sample solution.

$$( Circularity ) = ( Perimeter of the circle having the same area as the projected area of the particle image ) / ( Perimeter of the projected particle image ) \qquad Formula 1$$

The values of the volume average particle diameter (Dv), number average particle diameter (Dp) and average circularity of the toner particles do not show a significant difference with or without an external additive. Accordingly, the values of the volume average particle diameter (Dv), number average particle diameter (Dp) and average circularity of the toner containing the external additive can be deemed equal to those of the colored resin particles not containing the external additive.

In the toner of the present disclosure, from the viewpoint of suppression of fogging, the electrical conductivity of the toner extract is preferably 50 μS/cm or less, more preferably 40 μS/cm or less, and still more preferably 30 μS/cm or less. The electrical conductivity of the toner extract can be used as the degree of washability. The weaker the washing, the larger the amount of the dispersion stabilizer remaining in the toner. In general, the dispersion stabilizer contains an ionic component. Accordingly, as the amount of the dispersion stabilizer remaining in the toner increases, the electrical conductivity of the toner extract increases.

More specifically, the toner extract used to measure the electrical conductivity is obtained by dispersing 10 g of the toner in 100 mL a mixed solvent of IPA and deionized water (IPA/deionized water=80/20 (volume ratio)), stirring them at 50° C. for 30 minutes, and then separating the liquid component from the mixture.

The toner of the present disclosure may be used as a one-component toner consisting of the toner particles, or the toner particles may be mixed and stirred with carrier particles to make a two-component toner, and the two-component toner may be used as the toner of the present disclosure.

### 5. Toner Set

The toner set of the present disclosure is a color toner set comprising positively-chargeable toners of multiple colors for developing electrostatic images,
wherein the positively-chargeable toners of multiple colors for developing electrostatic images comprise at least a yellow toner, a magenta toner and a cyan toner, and
wherein all of the positively-chargeable toners of multiple colors for developing electrostatic images are the above-described positively-chargeable toners for developing electrostatic images according to the present disclosure.

That is, the toner set of the present disclosure is a toner set comprising a combination of the above-described toners of the present disclosure.

In an image containing a higher-order color (in the present disclosure, it may be simply referred to as “higher-order color image”) which is formed by use of the toner set of the present disclosure, the toner layers are less likely to peel. The reason is estimated as follows.

In the toner set of the present disclosure, since each of the toners constituting the toner set contains the combination of the styrene-acrylic resin and the polyester resin as the binder resin, the toners have low melt viscosity and are thus likely to melt compared to the case where only the styrene-acrylic resin is used as the binder resin. In addition, since each of the toners contains the ester wax as the release agent and the specific amount of the nonionic surfactant as the release agent disperser, excellent dispersibility of the ester wax in the colored resin particles is obtained, and the toners have a high plasticizing effect and are thus likely to melt. As just described, since the toners constituting the toner set of the present disclosure are likely to melt, in the formation of a higher-order color image using the toner set of the present disclosure, attachment of each of the toner layers is likely to progress. Accordingly, peeling of the toner layer(s) is suppressed, thereby improving the fixation of the toner layers. Peeling of the toner layer(s) means peeling of the toner layers from the surface of a paper, which occurs in the interface therebetween, peeling between the toner layers, and peeling occurring within the toner layer(s), for example. When at least one of the toners of the toner set contains only the hydrocarbon wax as the release agent, the compatibility between the binder resin and release agent of the toner is too high, and the release agent is likely to seep out to the surface of the toner particles when fixing the toner, accordingly. As a result, interfacial peeling is likely to occur between the toner particles forming the toner layer, and peeling is thus likely to occur within the toner layer.

Also, by the toner set of the present disclosure, a higher-order color image with excellent gloss uniformity can be formed. The reason is estimated as follows.

Since each of the toners constituting the toner set of the present disclosure uses the ester wax as the release agent, the crystallization speed of the release agent when the fixed toner is quickly cooled down, is slow. Accordingly, gloss unevenness is less likely to occur in each of the toner layers formed by use of the toner set of the present disclosure. Meanwhile, in a higher-order color image formed by use of the toner set, since multiple toner layers are stacked, the thickness of the whole toner layers increases. When the melt state of the whole toner layers is uneven at the time of fixing the higher-order color image on a recording material, the interfaces between the toner layers are roughened and, as a result, gloss unevenness is caused. Since the toners constituting the toner set of the present disclosure are, as described above, likely to melt, melting of the toner layers are likely to proceed when fixing the toners, and the uniformity of melting of the whole toner layers is high. Accordingly, the interfaces between the toner layers are less likely to be roughened. As a result, the higher-order color image formed by use of the toner set of the present disclosure obtains excellent gloss uniformity.

The toner set of the present disclosure may include, in addition to the yellow, cyan and magenta toners which are the reference yellow, cyan and magenta colors, another yellow, cyan or magenta toner or the like, which is different in color parameters (e.g., hue, color density, lightness and chroma) from the toner of the reference yellow, cyan or magenta color. In addition, the toner set of the present disclosure may include a black toner. Even when the toner set of the present disclosure includes a toner of a different color from the reference yellow, cyan or magenta color, all of the toners constituting the toner set are the above-described toners of the present disclosure.

The toners included in the toner set of the present disclosure are generally toners of different colors.

### 6. Image Forming Method

The toner set of the present disclosure is a color toner set for developing electrostatic images, which is typically used to form full-color images by electrostatic image development.

The method for forming a full-color image by electrostatic image development, is broadly classified into the following two methods, based on differences in transfer steps.
(1) A method in which an original image is subjected to color separation to obtain the data of color components; based on the data of the color components, single toner images of multiple colors are formed; the toner images are sequentially transferred onto one transfer medium to overlap the colors on the transfer medium, thereby forming a full-color image; and then the full-color image is transferred from the transfer medium to a recording medium.
(2) A method in which an original image is subjected to color separation to obtain the data of color components; based on the data of the color components, single toner images of multiple colors are formed; and the toner images are sequentially transferred onto one recording medium to overlap the colors on the recording medium, thereby forming a full-color image.

In the toner set of the present disclosure, in both of the above methods, the peeling of the toner layer(s) is less likely to occur, and a higher-order color image with excellent gloss uniformity can be formed.

The present disclosure also encompasses the following two image forming methods. One is the method in which the colors are overlapped on the transfer medium, and the other is the method in which the colors are overlapped on the recording medium.

The first method is a method for forming an image by an electrostatic image development type full-color printer using the toner set of the present disclosure,
the method comprising:
developing a first image which is a primary color image formed with the first toner (the first image developing step),
developing second images which are primary color images formed with the second toners (the second images developing step),
forming an image including a higher-order color on a transfer medium by transferring the first image and then the second images onto the transfer medium (the step of overlapping colors on a transfer medium),
transferring the image including the higher-order color formed on the transfer medium onto a recording medium (the higher-order color image transferring step), and
fixing the image including the higher-order color transferred onto the recording medium on the recording medium (the fixing step).

The second method is a method for forming an image by an electrostatic image development type full-color printer using the toner set of the present disclosure,
the method comprising:
developing a first image which is a primary color image formed with the first toner (the first image developing step),
developing second images which are primary color images formed with the second toners (the second images developing step),
forming an image including a higher-order color on a recording medium by transferring the first image and then the second images onto the recording medium (the step of overlapping colors on a recording medium), and
fixing the image including the higher-order color transferred onto the recording medium on the recording medium (the fixing step).

In the present disclosure, the term “primary color” means a color obtained by printing with a single color toner; the term “secondary color” means a color obtained by overlapping primary color toner images of two colors; and the term “higher-order color” means a color obtained by overlapping primary color toner images of multiple colors.

Also in the present disclosure, the term “toner image” literally means an image formed with a toner. In particular, the term is used to emphasize the following: the state that the toner is distributed according to an image required to be reproduced on an image holding surface such as a photoconductor, transfer medium or recording medium, is detected as a visual image.

Also in the present disclosure, the term “initial color” means the color of a primary color toner image which is transferred first onto a transfer receptive medium when a full-color image is formed as follows: primary color toner images of various colors are formed by use of toner developing devices; the toner images are sequentially transferred onto one transfer receptive medium (a recording medium or a transfer medium) to overlap the colors on the transfer receptive medium, thereby forming a full-color image.

Also in the present disclosure, the term “initial developing device” means a developing device used to develop a primary color toner image of the initial color. When toner developing devices are aligned in series along the conveyor path of the transfer receptive medium (recording medium or transfer medium) in a developing system, the developing device that the transfer receptive medium following the conveyor path meets first, is the “initial developing device”.

The toner set of the present disclosure is preferably applied to the following printing method: by use of primary color toners such as yellow, cyan and magenta toners, electrostatic latent images corresponding to the primary colors are developed to form primary color toner images on developing devices, and the obtained primary color toner images are sequentially transferred onto one transfer receptive medium selected from the group consisting of a recording medium and a transfer medium to overlap the colors on the transfer receptive medium, thereby forming a full-color image.

In the case of overlapping the colors on the recording medium, the primary color toner images are sequentially transferred from the surfaces having the toner images formed thereon of the developing devices onto the recording medium directly or via an intermediate transfer step of being transferred onto the transfer medium, thereby forming a full-color image including a higher-order color on the recording medium.

In the case of overlapping the colors on the transfer medium, the primary color toner images are sequentially transferred from the surfaces having the toner images formed thereon of the developing devices onto one transfer medium directly or via an intermediate transfer step of being transferred onto another preceding transfer medium, thereby forming a full-color image including a higher-order color on the transfer medium. Then, the full-color image formed on the transfer medium is transferred onto the recording medium directly or via an intermediate transfer step onto another subsequent transfer medium.

Of the toners included in the toner set of the present disclosure, one is used as the first toner, and other toners are used as the second toners. The first toner is a primary color toner which is transferred first onto the transfer receptive medium in the process of overlapping the colors on one transfer receptive medium selected from the group consisting of a recording medium and a transfer medium. The second toners are primary color toners which are transferred second or later in the process of overlapping the colors on the transfer receptive medium.

The first toner is generally selected from the group consisting of the yellow toner, the cyan toner and the magenta toner. The second toners are generally selected from the group consisting of the yellow toner, the cyan toner, the magenta toner and the black toner. The toners are generally toners of different colors.

As the transfer medium used to overlap the colors thereon, examples include, but are not limited to, an intermediate transfer belt and an intermediate transfer roller.

As the recording medium, examples include, but are not limited to, a coated paper, an art paper, an OHP sheet, as well as a recording paper such as a plain paper.

As the image forming device that can execute the above-mentioned process, the following full-color printer may be used, for example: a full-color printer in which developing devices corresponding to the color toners included in the toner set are aligned in series, and primary color images produced by the developing devices (color separation images) are sequentially transferred from the developing devices onto one recording medium directly or via a transfer medium to form an image including a secondary or higher-order color on the recording medium. This is a type of so-called tandem printer.

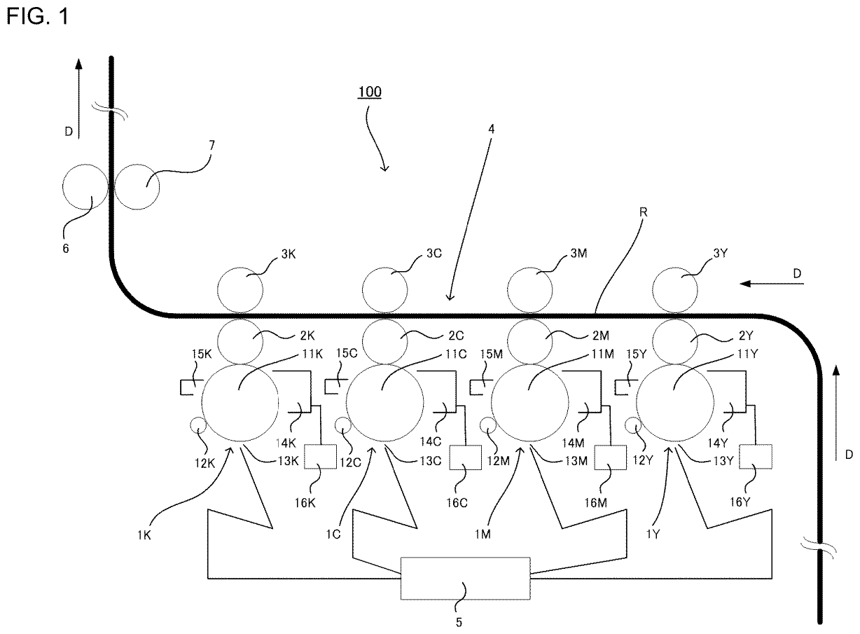

FIG. 1 is a schematic view of an example of the image forming device to which the toner set of the present disclosure is applicable. The image forming method of the present disclosure is not limited to the one shown in FIG. 1. The structure, size and form of the materials used in the method of the present disclosure are not limited to those of the materials shown in FIG. 1.

An image forming device 100 shown in FIG. 1 is a tandem printer. The image forming device 100 includes the following components: a conveyor path 4 for conveying a recording medium R; four developing devices 1Y, 1M, 1C and 1K corresponding to the four colors of yellow (Y), magenta (M), cyan (C) and black (K), respectively; transfer mediums 2Y, 2M, 2C and 2K and support rollers 3Y, 3M, 3C and 3K corresponding to the four developing devices 1Y, 1M, 1C and 1K, respectively; an exposure device 5 for applying laser light according to primary color image data obtained by color separation of the original image; and a fixing roller 6 and a support roller 7, which are paired with each other. The four developing devices 1Y, 1M, 1C and 1K corresponding to the four colors of yellow (Y), magenta (M), cyan (C) and black (K), respectively, are aligned in series along the conveying direction D of the recording medium R in the image forming device. The four developing devices are aligned in the following order from the upstream side of the conveying direction: the yellow developing device 1Y, the magenta developing device 1M, the cyan developing device 1C, and the black developing device 1K.

The structure of the developing devices will be described with reference to the yellow developing device 1Y as a representative example. The developing device 1Y includes a photoconductor 11Y in a drum form, and the following components are disposed around the photoconductor 11Y: a charging roller 12Y for charging the photoconductor surface to a predetermined voltage; a laser light irradiator 13Y for irradiating the photoconductor 11Y with the laser light produced in the exposure device to form an electrostatic image; a developing section 14Y for developing the electrostatic image by supplying a charged toner to the electrostatic image; the transfer medium 2Y in a roller form for transferring the developed toner image; and a cleaner 15Y for removal of the toner remaining on the photoconductor 11Y after the toner image is transferred onto the transfer medium. The developing section 14Y is connected to a toner storage 16Y through a yellow toner supply path.

As with the yellow developing device 1Y, the remaining developing devices of other colors include a photoconductor (11M, 11C, 11K), a charging roller (12M, 12C, 12K), a laser light irradiator (13M, 13C, 13K), a developing section (14M, 14C, 14K), a cleaner (15M, 15C, 15K) and a toner storage (16M, 16C, 16K). These components and a transfer medium (2M, 2C, 2K) are disposed around the photoconductor.

The method for forming an image by use of the image forming device 100 will be described. In this device, the yellow toner is selected as the first toner and used in the initial developing device 1Y. The magenta (M), cyan (C) and black (K) toners are used in the second and subsequent developing devices as the second toners.

First, in the yellow developing device 1Y, the surface of the photoconductor 11Y is uniformly charged by the charging roller 12Y. A photoconductor generally has high resistance (the resistance of general resin); however, it is characterized in that once irradiated with laser light, the specific resistance of a laser-irradiated part is changed. Accordingly, laser light is produced by the exposure device 5 according to the primary color image data of yellow, and the surface of the charged photoconductor 1Y is irradiated with the laser light by the laser light irradiator 13Y. A photosensitive layer on the surface of the photoconductor 11Y is irradiated with the laser light, thereby forming an electrostatic latent image corresponding to the primary color image of yellow on the surface of the photoconductor 11Y.

The electrostatic latent image is formed by the charge left in a part not irradiated with the laser light. Accordingly, it is a negative latent image.

The electrostatic latent image on the photoconductor 11Y is moved to the position of the developing section 14Y by the rotation of the photoconductor, and the electrostatic latent image is developed there to obtain a primary color toner image of yellow.

The primary color toner image of yellow on the photoconductor is moved to the primary transfer position by the rotation of the photoconductor. At the primary transfer position, the surface of the photoconductor 11Y and the surface of the transfer medium 2Y are brought into contact with each other. Accordingly, the primary color toner image of yellow on the photoconductor undergoes primary transfer to the surface of the transfer medium 2Y.

By the rotation of the transfer medium, the primary color toner image of yellow on the transfer medium 2Y is moved to the position where the primary color toner image of yellow undergoes secondary transfer. At the secondary transfer position, the recording medium R on the conveyor path 4 is sandwiched between the transfer medium 2Y and the support roller 3Y, and the surface of the transfer medium 2Y and the image receptive surface of the recording medium R are brought into contact with each other. Accordingly, the primary color toner image of yellow on the transfer medium 2Y undergoes secondary transfer onto the recording medium R.

Next, in the magenta developing device 1M, the same process as the process of forming the primary color toner image of yellow is executed. That is, in the magenta developing device 1M, a primary color toner image of magenta is formed on the surface of the photoconductor 11M; the formed image undergoes primary transfer to the surface of the transfer medium 2M; and then the transferred image is moved to the position where the primary color toner image of magenta undergoes secondary transfer by the rotation of the transfer medium 2M. Meanwhile, a part having the primary color toner image of yellow formed thereon of the recording medium R is moved from the upstream side of the conveyor path 4 and reaches the position where the primary color toner image of magenta undergoes secondary transfer. The primary color toner image of magenta on the transfer medium 2M is aligned there with the primary color toner image of yellow on the recording medium R and undergoes secondary transfer onto the recording medium R.

Next, in the cyan developing device 1C and the black developing device 1K, the same process as the process of forming the primary color toner image of yellow is executed. Then, the primary color toner images of yellow (Y), magenta (M), cyan (C) and black (K) are overlapped in this order on the recording medium R moved by the conveyor path, thereby obtaining a full-color image including a higher-order color. The recording medium R passes through all of the developing devices, and after the image including the higher-order color is formed, the recording medium R moves to the position where the fixing step is carried out. At that position, the recording medium R is sandwiched between the fixing roller 6 and the support roller 7. Accordingly, the image including the higher-order color is fixed on the recording medium.

### EXAMPLES

Hereinafter, the present disclosure will be described further in detail, with reference to the following examples and comparative examples. However, the present disclosure is not limited to these examples. Herein, part(s) and % are on a mass basis unless otherwise noted.

The weight average molecular weight Mw and number average molecular weight Mn of the resin were each determined as a polystyrene equivalent molecular weight measured by GPC. A sample for measurement was obtained as follows: a polymer was dissolved in tetrahydrofuran (THF) so as to have a concentration of 2 mg/mL, and an ultrasonic treatment was carried out thereon for 10 minutes, followed by filtration through a 0.45 μm membrane filter, thereby obtaining the sample for measurement. The measurement conditions were as follows: temperature: 40° C., solvent: tetrahydrofuran, flow rate: 1.0 mL/min, concentration: 0.2 wt. %, and sample input amount: 100 μL. As a column, GPC TSKGEL MULTIPORE HXL-M (30 cm×2) manufactured by Tosoh Corporation, was used.

### Production Example 1: Production of Magenta Pigment A

2,5-Di-(4-methylphenylamino) terephthalic acid was cyclized in phosphoric acid to synthesize 2,9-dimethylquinacridone (C.I. Pigment Red 122). Water was added to the obtained phosphoric acid dispersion of 2,9-dimethylquinacridone, and the 2,9-dimethylquinacridone was filtered off by a filter and washed with water. Water was added again to the washed 2,9-dimethylquinacridone to obtain an aqueous dispersion having a solid content of 20%.

Similarly, 2,5-di-phenylaminoterephthalic acid was used to produce an aqueous dispersion of quinacridone (C.I. Pigment Violet 19) with a solid content of 20%.

To 250 parts of the aqueous dispersion of the dimethylquinacridone (C.I. Pigment Red 122) having a solid content of 20% and 250 parts of the aqueous dispersion of the quinacridone (C.I. Pigment Violet 19) having a solid content of 20%, 250 parts of ethanol were added to obtain a mixture liquid of pigments. The mixture was transferred to a container equipped with a cooling tube and allowed to react under heating reflux for 5 hours, while grinding the pigments. After completion of the reaction, the pigment was filtered off from the reaction solution, washed, dried and then pulverized to obtain a magenta pigment A which was a mixed crystal of the magenta pigments (that is, a mixed crystal of C.I. Pigment Red 122 and C.I. Pigment Violet 19). The mass ratio of C.I. Pigment Red 122 to C.I. Pigment Violet 19 contained in the mixed crystal was 1:1.

### Production Example 2: Production of Polyester Resin (1)

First, 536 parts of 4-methyl-hexahydrophthalic anhydride, 100 parts of hexahydroterephthalic acid bis(5-hydroxyethyl), 30 parts of a 5-aminohexahydroisophthalic acid dimethyl ester, 284 parts of hydrogenated bisphenol A and 150 parts of ethylene glycol were fed into a three-necked flask equipped with a stirrer, a thermometer, a reflux cooling tube, a water distribution tube and a nitrogen gas inlet tube. The ratio of the total hydroxyl value (X) to the total acid value (Y) (the (X)/(Y) ratio) was 1.07. While introducing nitrogen gas, they were mixed by stirring. The mixture was reacted at 200° C. for three hours, while removing alcohol generated during the reaction. Next, 5 parts of tetrabutoxy titanate was added. The reaction temperature was increased to 220° C., and the pressure inside the flask was gradually decreased. After a lapse of 1.5 hours, the pressure was decreased to 5 mmHg or less. Then, the reaction was further continued for three hours, thereby obtaining a polyester resin (1).

The obtained polyester resin (1) had a number average molecular weight of 3,000, a weight average molecular weight of 14,000, a hydroxyl value of 38 mgKOH/g, and a glass transition temperature of 65° C.

### Production Example 3: Production of Polyester Resin (2)

First, 93 parts of 1,4-cyclohexanedicarboxylic acid, 7 parts of 1,3,5-cyclohexanetricarboxylic acid, 60 parts of hydrogenated bisphenol A and 40 parts of 1,4-cyclohexanediol were fed into a three-necked flask equipped with a stirrer, a thermometer, a reflux cooling tube, a water distribution tube and a nitrogen gas inlet tube. While introducing nitrogen gas, they were mixed by stirring. The mixture was reacted at 200° C. for 5 hours, while removing water generated during the reaction. Next, 0.5 parts of iron acetylacetonate was added. The reaction temperature was increased to 220° C., and the pressure inside the flask was gradually decreased. After a lapse of 1.5 hours, the pressure was decreased to 5 mmHg or less. Then, the reaction was further continued for 5 hours, thereby obtaining a polyester resin (2).

The obtained polyester resin (2) was a transparent light-yellow solid having a number average molecular weight of 8,500, a weight average molecular weight of 28,000 and a glass transition temperature of 62° C.

### Production Example 4: Production of Acidic Group-Containing Acrylic Resin P1

First, 200 parts of toluene was put in a reaction container. While stirring the toluene, the gas inside the reaction container was sufficiently replaced with nitrogen. Then, the temperature of the toluene was increased to 90° C. Then, a mixed solution of 97.0 parts of methyl methacrylate, 2.6 parts of ethyl acrylate, 0.4 parts of acrylic acid, and 3 parts of t-butylperoxy-2-ethylhexanoate (product name: PERBUTYL O, manufactured by NOF Corporation) was added dropwise to the reaction container for two hours. Also, the condition of the mixture was maintained for 10 hours under toluene flux, thereby completing polymerization. Then, the solvent was removed by distillation under reduced pressure, thereby obtaining an acidic group-containing acrylic resin P1 (MMA/EA/AA). The acidic group-containing acrylic resin P1 had an acid value of 2.5 mgKOH/g, a Tg of 74° C., and a Mw of 12600.

### Example 1

1. Production of colored resin particles

### (1) Preparation of Polymerizable Monomer Composition for Core

First, 74 parts of styrene, 26 parts of n-butyl acrylate, 0.1 parts of a polymethacrylic acid ester macromonomer (product name: AA-6; manufactured by: TOAGOSEI Co., Ltd.; Tg: 94° C.) and 5 parts of the polyester resin (1) obtained in Production Example 2 as the binder resin, 0.50 parts of tetraethyl thiuram disulfide as the molecular weight modifier, and a yellow pigment (6.5 parts of C.I. Pigment Yellow 214 and 1.5 parts of C.I. Solvent Yellow 98) as the colorant, were wet-pulverized by means of a media-type disperser (product name: PICOMILL, manufactured by: ASADA IRON WORKS. Co., Ltd.)

To the mixture obtained by the wet pulverization, 12.0 parts of a synthetic ester wax 1 (hexaglycerin octabehenate, melting point 70° C.) as a release agent and 0.1 parts of a nonionic surfactant A (a polyoxyethylene (distyrenated phenyl) ether, product name: EMULGEN A-60, manufactured by: Kao Corporation, the average number of moles of added polyoxyethylene: 13) as a release agent disperser were added, and they were mixed. To the mixture thus obtained, 5.0 parts of a styrene-acrylic resin containing a quaternary ammonium salt (the functional group amount: 0.5% by mass) as a charge control resin, 2.0 parts of a styrene-based thermoplastic elastomer (a styrene-isoprene-styrene block copolymer, product name: QUINTAC 3270, manufactured by: ZEON Corporation, the styrene unit content: 24% by mass, the weight average molecular weight Mw: 106,000) and 1.0 part of the acidic group-containing acrylic resin P1 obtained in Production Example 4 were further added, mixed and dissolved to prepare a polymerizable monomer composition for core.

### (2) Preparation of Aqueous Dispersion Medium

An aqueous solution in which 7.3 parts of sodium hydroxide was dissolved in 50 parts of deionized water, was gradually added under stirring to an aqueous solution in which 10.4 parts of magnesium chloride was dissolved in 280 parts of deionized water, thereby preparing a magnesium hydroxide colloidal dispersion.

### (3) Preparation of Polymerizable Monomer for Shell

An aqueous dispersion of a polymerizable monomer for shell was prepared by finely dispersing 2 parts of methyl methacrylate and 130 parts of water by means of an ultrasonic emulsifier.

### (4) Droplets Forming Step

The polymerizable monomer composition for core was added to the magnesium hydroxide colloidal dispersion (the magnesium hydroxide amount: 5.3 parts), and the mixture was further stirred. Then, as a polymerization initiator, 6 parts of t-butylperoxy-2-ethylbutanoate was added thereto. The dispersion mixed with the polymerization initiator was dispersed at a rotational frequency of 15,000 rpm by an in-line type emulsifying and dispersing machine (product name: MILDER, manufactured by: Pacific Machinery & Engineering Co., Ltd.) to form the polymerizable monomer composition for core into droplets.

### (5) Suspension Polymerization Step

The dispersion containing the droplets of the polymerizable monomer composition for core was placed in a reactor, and the temperature of the dispersion was raised to 90° C. to initiate a polymerization reaction. After reaching the polymerization conversion rate of almost 100%, a solution prepared by dissolving, as a polymerization initiator for shell, 0.1 parts of 2,2′-azobis[2-methyl-N-(2-hydroxyethyl)-propionamide](product name: VA-086, manufactured by: Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

### (6) Post-Treatment Step

The aqueous dispersion of the colored resin particles was subjected to acid washing (30° C., 10 minutes) by adding, while stirring the aqueous dispersion, sulfuric acid to the dispersion until the pH of the dispersion reached 4.5 or less. Then, the colored resin particles were separated by filtration and washed with water. The washing water was filtered. The electrical conductivity of the filtrate at this time was 10 μS/cm. Next, the colored resin particles were dehydrated and dried to obtain the colored resin particles in a dry state.

### 2. Production of Toner

To 100 parts of the colored resin particles, 0.2 parts of hydrophobized silica fine particles having an average particle diameter of 7 nm, 0.76 parts of hydrophobized silica fine particles having an average particle diameter of 20 nm, and 1.91 parts of hydrophobized silica fine particles having an average particle diameter of 50 nm were added. They were mixed by use of a high-speed stirring machine (product name: FM MIXER, manufactured by: Nippon Coke & Engineering Co., Ltd.), thereby preparing the toner of Example 1.

### Examples 2 and 3

The toners of Examples 2 and 3 were obtained in the same manner as Example 1, except that in “(1) Preparation of polymerizable monomer composition for core” under “1. Production of colored resin particles”, the type of the colorant was changed according to the following Table 1.

The cyan pigment used in Example 2 was C.I. Pigment Blue 15:3. The magenta pigment A used in Example 3 was the magenta pigment A obtained in Production Example 1.

### Examples 4 to 7 and Comparative Examples 2, 3, 5 and 6

The toners of Examples 4 to 7 and Comparative Examples 2, 3, 5 and 6 were obtained in the same manner as Example 1, except that in “(1) Preparation of polymerizable monomer composition for core” under “1. Production of colored resin particles”, the type of the added release agent disperser, the amount thereof or both of them were changed according to the following Table 1 or 2.

The nonionic surfactant B used in Example 4 was a polyoxyethylene lauryl ether (product name: EMULGEN 120, manufactured by: KAO Corporation). The nonionic surfactant C used in Example 5 was a polyoxyethylene lauryl ether (product name: EMULGEN 109P, manufactured by: KAO Corporation). The anionic surfactant A used in Comparative Example 5 was NEOGEN (registered trademark) (product name, a linear alkylbenzene sulfonate or sodium alpha-olefin sulfonate manufactured by DKS Co. Ltd.) The cationic surfactant A used in Comparative Example 6 was an alkylbenzyldimethylammonium chloride (product name: SANISOL (registered trademark) B50, manufactured by: KAO Corporation). In Comparative Example 2, a release agent disperser was not added.

### Examples 8 and 9 and Comparative Example 1

The toners of Examples 8 and 9 and Comparative Example 1 were obtained in the same manner as Example 1, except that in “(1) Preparation of polymerizable monomer composition for core” under “1. Production of colored resin particles”, the type or amount of the added polyester resin was changed according to the following Table 1 or 2.

The polyester resin (2) used in Example 9 was the polyester resin (2) obtained in Production Example 3. In Comparative Example 1, a polyester resin was not added.

### Comparative Example 4

The toner of Comparative Example 4 was obtained in the same manner as Example 1, except that in “(1) Preparation of polymerizable monomer composition for core” under “1. Production of colored resin particles”, the type of the release agent was changed according to the following Table 2.

The hydrocarbon wax used in Comparative Example 4 was a natural gas-based Fischer-Tropsch wax (product name: FT-100, manufactured by: Shell MDS) having an endothermic peak temperature of 93° C., a weight average molecular weight of 1000 and a number average molecular weight of 670.

### Example 10

The toner of Example 10 was obtained in the same manner as Example 1, except that in “(1) Preparation of polymerizable monomer composition for core” under “1. Production of colored resin particles”, the type of the colorant was changed according to the following Table 3, and a styrene-based thermoplastic elastomer was not added.

The magenta pigment A used in Example 10 was the magenta pigment A obtained in Production Example 1.

### Example 11

The toner of Example 11 was obtained in the same manner as Example 1, except that in “(1) Preparation of polymerizable monomer composition for core” under “1. Production of colored resin particles”, the amount of the added nonionic surfactant A was changed according to the following Table 3.

### Example 12

The toner of Example 12 was obtained in the same manner as Example 1, except that in “(1) Preparation of polymerizable monomer composition for core” under “1. Production of colored resin particles”, as the charge control resin, 5.0 parts of a styrene-acrylic resin containing a quaternary ammonium salt (functional group amount: 15% by mass, product name: FCA-201-PS, manufactured by: Fujikura Kasei Co., Ltd.) was used instead of 5.0 parts of the styrene-acrylic resin containing a quaternary ammonium salt (functional group amount: 0.5% by mass).

### Example 13 and 14

The toners of Examples 13 and 14 were obtained in the same manner as Example 1, except that in “(1) Preparation of polymerizable monomer composition for core” under “1. Production of colored resin particles”, the type of the release agent was changed according to the following Table 3.

The ester wax 2 shown in the following Table 3 is pentaerythritol tetrabehenate (melting point 76° C.), and the ester wax 3 shown therein is behenyl stearate (melting point 67° C.).

### Example 15

The toner of Example 15 was obtained in the same manner as Example 1, except that in “(1) Preparation of polymerizable monomer composition for core” under “1. Production of colored resin particles”, 5 parts of C.I. Pigment Blue 15:3 was used instead of the yellow pigments (6.5 parts of C.I. Pigment Yellow 214 and 1.5 parts of C.I. Solvent Yellow 98).

### Example 16

The toner of Example 16 was obtained in the same manner as Example 1, except that in “(1) Preparation of polymerizable monomer composition for core” under “1. Production of colored resin particles”, 8 parts of C.I. Pigment Red 122 was used instead of the yellow pigments (6.5 parts of C.I. Pigment Yellow 214 and 1.5 parts of C.I. Solvent Yellow 98).

### Examples 17 and 18

The toners of Examples 17 and 18 were obtained in the same manner as Example 1, except that in “(1) Preparation of polymerizable monomer composition for core” under “1. Production of colored resin particles”, the amount of the added ester wax 1 and that of the added nonionic surfactant A were changed according to the following Table 3.

### Examples 19 and 20

The toners of Examples 19 and 20 were obtained in the same manner as Example 1, except that in “(1) Preparation of polymerizable monomer composition for core” under “1. Production of colored resin particles”, the type and amount of the added release agent were changed according to the following Table 3. The hydrocarbon wax shown in Table 3 is the same as the wax used in Comparative Example 4.

### Examples 21 to 23

The toners of Examples 21 to 23 were obtained in the same manner as Example 1, except that in “(1) Preparation of polymerizable monomer composition for core” under “1. Production of colored resin particles”, the type and amount of the added release agent disperser were changed according to the following Table 3. The nonionic surfactant D shown in Table 3 is a polyoxyalkylene alkenyl ether (product name: LATEMUL PD-420, manufactured by: KAO Corporation); the anionic surfactant B shown therein is a sodium polyoxyethylene lauryl ether sulfate (manufactured by: KAO Corporation); and the anionic surfactant C shown therein is dodecylbenzenesulfonic acid.

### [Measurement and Evaluation of the Toner]

### (1) Average Circularity

First, 10 mL of deionized water was poured into a container. As a dispersant, 0.2 g of a surfactant aqueous solution (product name: DRIWEL, manufactured by: Fujifilm Corporation) was added thereto. In addition, 0.2 g of the toner was further added thereto. The mixture was subjected to a dispersion treatment for 3 minutes at 60 W with an ultrasonic disperser. The concentration of the toner particles at the time of measurement was adjusted to be from 3000 particles/μL to 10,000 particles/μL. By means of a flow type particle image analyzer (product name: FPIA-2100, manufactured by: Sysmex Corporation), 1,000 to 10,000 toner particles having a circle equivalent diameter of 0.4 μm or more, were measured. From the measured values thus obtained, the average circularity was obtained.

The circularities of the measured particles were obtained by the following formula. The average circularity was the average value of the circularities.

$$( Circularity ) = ( Perimeter of the circle having the same area as the projected area of the particle image ) / ( Perimeter of the projected particle image )$$

### (2) Volume Average Particle Diameter (Dv), Number Average Particle Diameter (Dp) and Particle Size Distribution (Dv/Dp)

First, about 0.1 g of the toner was weighed out and put in a beaker. Next, as a dispersant, 0.1 mL of a surfactant aqueous solution (product name: DRIWEL, manufactured by: Fujifilm Corporation) was added thereto. Next, 10 mL to 30 mL of ISOTON II was put in the beaker. The mixture was dispersed for 3 minutes with a 20 W (watt) ultrasonic disperser. Then, the volume average particle diameter (Dv) and number average particle diameter (Dp) of the toner particles were measured with a particle size analyzer (product name: MULTISIZER, manufactured by Beckman Coulter, Inc.) under the following condition: aperture diameter: 100 μm, medium: ISOTON II, and the number of measured particles: 100,000 particles. Then, the particle size distribution (Dv/Dp) was calculated.

### (3) Heat Resistant Temperature

First, 10 g of the toner was put in a 100 mL polyethylene container, and the container was hermetically sealed. Then, the container was placed in a constant temperature water bath at a predetermined temperature that was set by changing the bath temperature 1° C. by 1° C. from 50° C. After 8 hours passed, the container was removed from the constant temperature water bath. The toner was transferred from the removed container onto a 42-mesh sieve in a manner preventing vibration as much as possible. Then, it was set in a powder characteristic tester (product name: POWDER TESTER (registered trademark) PT-R, manufactured by: Hosokawa Micron Corporation). The amplitude condition of the sieve was set to 1.0 mm, and the sieve was vibrated for 30 seconds. Then, the mass of the toner remaining on the sieve was measured, and the thus-measured mass was determined as an aggregated toner mass.

The maximum temperature at which the aggregated toner mass became 0.5 g or less, was determined as the heat resistant temperature of the toner. As the heat resistant temperature increases, blocking of the toner is less likely to occur during storage, and the storage stability of the toner improves. In the following evaluation criteria, it can be evaluated that the storage stability of the toner improves in the order of C<B<A, and D is failure.

### (Evaluation Criteria for Heat Resistant Temperature)

A: The heat resistant temperature was 59° C. or more.
B: The heat resistant temperature was 56° C. or more and less than 59° C.
C: The heat resistant temperature was 53° C. or more and less than 56° C.
D: The heat resistant temperature was less than 53° C.

### (4) Fixing Temperature

A commercially-available, non-magnetic one-component developing printer was modified such that the temperature of the fixing roller was changeable. While the temperature of the fixing roller of the printer was changed 5° C. by 5° C. from 120° C., the fixing rate at each changed temperature was measured. The relationship between the temperature and the fixing rate was determined, and the lowest temperature at which the fixing rate of 80% or more was obtained, was defined as the fixing temperature of the toner. The lower the fixing temperature, the better the low temperature fixability of the toner.

The fixing rate was calculated from the image density ratio before and after a rubbing test operation of a solid area on a test paper sheet printed by the printer. The fixing rate was obtained by the following formula where “ID (before)” is the image density before the rubbing test and “ID (after)” is the image density after the rubbing test.

$$Fixing rate ( \% ) = [ ID ( after ) / ID ( before ) ] \times 100$$

The rubbing test was carried out by attaching the measurement area of the test paper sheet to a fastness tester with an adhesive tape, applying a 500 g load, and carrying out reciprocating rubbing 5 times with a rubbing terminal wrapped with a cotton cloth. In the following evaluation criteria, it can be evaluated that the low temperature fixability improves in the order of C<B<A, and D is failure.

### (Evaluation Criteria for Fixing Temperature)

A: The fixing temperature was less than 155° C.
B: The fixing temperature was 155° C. or more and less than 170° C.
C: The fixing temperature was 170° C. or more and less than 185° C.
D: The fixing temperature was 185° C. or more.

### (5) Initial Fogging Test

Printing paper sheets were set in a commercially-available, non-magnetic one-component development printer (printing speed: 30 sheets/min), and the toner was put in the developing device of the printer. The printer was left for 24 hours in a high-temperature and high-humidity (H/H) environment at a temperature of 35° C. and a humidity of 80% RH. In the same environment, three sheets were continuously printed at an image density of 5%.

Then, solid pattern printing (image density 0%) was carried out, and the printer was stopped in the middle of the solid pattern printing. A piece of an adhesive tape (product name: SCOTCH MENDING TAPE 810-3-18, manufactured by: Sumitomo 3M Limited) was attached to a non-image area on the photoconductor of the printer after development, thereby making the toner in the area adhere to the tape piece. Then, the tape piece was attached to a printing paper sheet. Next, the whiteness degree (B) of the printing paper sheet on which the tape piece was attached, was measured with a whiteness colorimeter (manufactured by Nippon Denshoku Industries Co., Ltd.) In the same manner, an unused piece of the adhesive tape was attached to the printing paper sheet, and the whiteness degree (A) was measured. The difference (B−A) between the whiteness degrees (B) and (A) was determined as a fog value. As the fog value gets smaller, fogging decreases and better printing is obtained. In the following evaluation criteria, it can be evaluated that fogging is less likely to occur and the toner improves in the order of C<B<A, and D is failure.

### (Evaluation Criteria for Initial Fogging)

A: The fog value was 0 or more and less than 2.
B: The fog value was 2 or more and less than 4.
C: The fog value was 4 or more and less than 8.
D: The fog value was 8 or more.

### (6) Gloss Unevenness

The toner was put in a commercially-available, non-magnetic one-component development printer. In an environment at a temperature of 23° C. and a humidity of 50% RH, a 5 cm×5 cm square solid pattern was printed on a sheet of printing paper. At this time, a developing amount M/A, which is the amount of the toner on the printing paper sheet, was changed by changing a developing bias voltage. The developing amount M/A was calculated as follows: an unfixed image was removed from the printer; the toner developed on the printing paper sheet was blown off by air; and the developing amount M/A was calculated by the following formula.

$$M / A ( mg / {cm}^{2} ) = ( {W}_{1} - {W}_{2} ) / 25 {cm}^{2}$$

W₁: The weight (mg) of the printing paper sheet before the toner was blown off.
W₂: The weight (mg) of the printing paper sheet after the toner was blown off.

The gloss of the fixed image of the 5 cm×5 cm square solid pattern which had a M/A of 0.35 mg/cm², was measured. More specifically, at the four corners and center of the obtained solid image of 5 cm square, that is, at the total of 5 points, the gloss value was measured with a gloss meter (product name: VGS-SENSOR, manufactured by: Nippon Denshoku Industries Co., Ltd.) at an incident angle of 60°. From the gloss values of the 5 points, the maximum and minimum values were obtained; the average value of the 5 gloss values was obtained; and the gloss unevenness was calculated by the following calculation formula.

$$Gloss unevenness ( \% ) = \{ ( Maximum value - Minimum value ) / Average value \} \times 100$$

In the following evaluation criteria, it can be evaluated that the gloss unevenness diminishes and the toner improves in the order of C<B<A, and D is failure.

### (Evaluation Criteria for Gloss Unevenness)

A: The gloss unevenness was less than 20%.
B: The gloss unevenness was 20% or more and less than 25%.
C: The gloss unevenness was 25% or more and less than 30%.
D: The gloss unevenness was 30% or more.

### (7) Surfactant Amount on the Toner Particle Surface

### (7-1) Extraction of the Nonionic Surfactant

In Examples 1 to 23 and Comparative Examples 1 to 4, a toner extract was prepared by dispersing 10 g of the toner in 100 mL a mixed solvent of IPA and deionized water (IPA/deionized water=80/20 (volume ratio)), stirring them at 50° C. for 30 minutes, and then separating the liquid component from the mixture.

Next, the obtained toner extract was treated with a weakly basic anion-exchange resin (product name: DIAION WK10, manufactured by: Mitsubishi Chemical Corporation) and a weakly acidic cation-exchange resin (product name: DIAION WK20, manufactured by: Mitsubishi Chemical Corporation). The treated toner extract was used to measure the surfactant amount described below.

The above-described treatment with the ion-exchange resin was a treatment for removing the ionic surfactant. In Examples 1 to 9, Comparative Examples 1 to 4, Examples 10 to 20 and Example 23, the presence or absence of the treatment with the ion-exchange resin had no influence on the measurement result since any ionic surfactant was not used. In Examples 21 and 22, the anionic surfactant was removed by the treatment with the ion-exchange resin, and the amount of the nonionic surfactant was measured.

### (7-2) Extraction of the Ionic Surfactant

In Comparative Examples 5 and 6 and Examples 21 and 22, after the toner extraction was prepared in the same manner as the above-described extraction of the nonionic surfactant, the toner extraction was used as it was to measure the surfactant amount, without the treatment with the ion-exchange resin. In Comparative Examples 5 and 6, since only the ionic surfactant was used as the release agent disperser, the amount of the ionic surfactant was measured. In Examples 21 and 22, since the toner extract contained the nonionic surfactant and the ionic surfactant, the amount of the ionic surfactant only was measured by assigning the peak of the ionic surfactant to the peak of the material.

### (7-3) Measurement of the Surfactant Amount

The amount of the surfactant contained in the toner extract was measured by the liquid chromatography mass spectrometry analysis (LC/MS). Details of the measurement method were as follows.

First, each of the materials contained in the toner was measured by LC/MS to identify the peak (molecular weight) assigned to the materials. Next, the toner extract was measured by LC/MS to detect peaks. Based on the results of the materials measured in advance, the peaks of the materials other than the surfactant were excluded from the peaks detected from the toner extract, thereby obtaining the surfactant amount.

The LC/MS measurement conditions were as follows.

### (LC/MS Measurement Conditions)

Liquid chromatography mass spectrometer: UPLC H-Class, Xevo G2-XS QTof (manufactured by Waters Corporation)
LC condition
   Device: UPLC H-Class
   Columns: ACQUITY UPLC C8 (1.7 μm, 2.1 mm×100 mm)
   Column temperature: 40° C.
   Mobile phase: (A) 0.1% Formic acid, (B) MeOH containing
0.1% formic acid
   Flow rate: 0.5 mL/min
   Injected amount: 2 μL
MS condition
   Device: Xevo G2-XS Q-Tof
   Ionization mode: ESI positive/negative
   Capillary voltage: 1.0 kV/2.5 kV
   Desolvation gas: 1000 L/hr, 500° C.
   Cone gas: 50 L/hr
   Cone voltage: 40 V (offset: 80 V)
   Collision energy: 2 eV
   Measurement range: m/z 100-1000
   Measurement mode: MS Sensitivity Mode (resolution/30,000)
MS/MS condition
   Collision energy
   Low energy: 6 eV
   High energy: 30 eV to 50 eV (ramp start to end)

The amount of a long-chain fatty acid-polyether-based nonionic surfactant, the fatty acid containing 12 to 22 carbon atoms, can be approximately obtained from the intensity of the peak of m/z=160-320 which is derived from the long-chain fatty acid containing 12 to 22 carbon atoms.

### (8) Electrical Conductivity of the Toner Extract

The toner extract was prepared by dispersing 10 g of the toner in 100 mL a mixed solvent of IPA and deionized water (IPA/deionized water=80/20 (volume ratio)), stirring them at 50° C. for 30 minutes, and then separating the liquid component from the mixture. The electrical conductivity of the obtained toner extract was measured at a temperature of 25° C. t 0.5° C. using an electrical conductivity meter (product name: ES-12, manufactured by: HORIBA, Ltd.) Deionized water having an electrical conductivity of 0.8 μS/cm or less was used.

TABLE 1

| | | Example 1 | Example 2 | Example 3 | Example 4 | Example 5 |
|---|---|---|---|---|---|---|
| Toner No. | | Y-1 | C-1 | M-1 | Y-2 | Y-3 |
| Binder resin | Styrene (Parts) | 74 | 74 | 74 | 74 | 74 |
| | Butyl acrylate (Parts) | 26 | 26 | 26 | 26 | 26 |
| | AA-6 (Parts) | 0.1 | 0.1 | 0.1 | 0.1 | 0.1 |
| | Polyester resin (1) | 5 | 5 | 5 | 5 | 5 |
| | (Parts) | | | | | |
| | Polyester resin (2) | | | | | |
| | (Parts) | | | | | |
| Styrene-acrylic resin:Polyester | | 95.2:4.8 | 95.2:4.8 | 95.2:4.8 | 95.2:4.8 | 95.2:4.8 |
| resin (Mass ratio) | | | | | | |
| Colorant | Type | Yellow pigment | Cyan pigment | Magenta | Yellow pigment | Yellow pigment |
| | | (PY214, SY98) | (PB15:3) | pigment A | (PY214, SY98) | (PY214, SY98) |
| | | | | (PR122, PV19) | | |
| | (Parts) | 8 | 8 | 8 | 8 | 8 |
| Release agent | Type | Ester wax 1 | Ester wax 1 | Ester wax 1 | Ester wax 1 | Ester wax 1 |
| | (Parts) | 12 | 12 | 12 | 12 | 12 |
| Release agent | Type | Nonionic | Nonionic | Nonionic | Nonionic | Nonionic |
| disperser | | surfactant A | surfactant A | surfactant A | surfactant B | surfactant C |
| | (Parts) | 0.1 | 0.1 | 0.1 | 0.1 | 0.2 |
| Charge control | Functional group amount | 0.5 | 0.5 | 0.5 | 0.5 | 0.5 |
| resin | (% by mass) | | | | | |
| | (Parts) | 5 | 5 | 5 | 5 | 5 |
| Styrene-based | (Parts) | 2 | 2 | 2 | 2 | 2 |
| thermoplastic | | | | | | |
| elastomer | | | | | | |
| Acidic group- | (Parts) | 1 | 1 | 1 | 1 | 1 |
| containing | | | | | | |
| acrylic resin | | | | | | |
| Toner | Average circularity | 0.992 | 0.993 | 0.987 | 0.980 | 0.985 |
| evaluation | Dv/Dp | 1.10 | 1.11 | 1.13 | 1.11 | 1.10 |
| | Heat resistant | A | A | A | A | B |
| | temperature | | | | | |
| | Fixing temperature | A | A | A | B | B |
| | Initial fogging test | A | A | A | A | A |
| | Gloss unevenness | A | A | A | A | A |
| | Surfactant amount (ppm) | 48 | 48 | 48 | 50 | 80 |
| | on toner particle surface | | | | | |
| | Electrical conductivity | 10 | 17 | 8 | 20 | 12 |
| | (μS/cm) of toner extract | | | | | |

| | | Example 6 | Example 7 | Example 8 | Example 9 |
|---|---|---|---|---|---|
| Toner No. | | Y-4 | Y-5 | Y-6 | Y-7 |
| Binder resin | Styrene (Parts) | 74 | 74 | 74 | 74 |
| | Butyl acrylate (Parts) | 26 | 26 | 26 | 26 |
| | AA-6 (Parts) | 0.1 | 0.1 | 0.1 | 0.1 |
| | Polyester resin (1) | 5 | 5 | 10 | |
| | (Parts) | | | | |
| | Polyester resin (2) | | | | 5 |
| | (Parts) | | | | |
| Styrene-acrylic resin:Polyester | | 95.2:4.8 | 95.2:4.8 | 90.9:9.1 | 95.2:4.8 |
| resin (Mass ratio) | | | | | |
| Colorant | Type | Yellow pigment | Yellow pigment | Yellow pigment | Yellow pigments |
| | | (PY214, SY98) | (PY214, SY98) | (PY214, SY98) | (PY214, SY98) |
| | (Parts) | 8 | 8 | 8 | 8 |
| Release agent | Type | Ester wax 1 | Ester wax 1 | Ester wax 1 | Ester wax 1 |
| | (Parts) | 12 | 12 | 12 | 12 |
| Release agent | Type | Nonionic | Nonionic | Nonionic | Nonionic |
| disperser | | surfactant A | surfactant A | surfactant A | surfactant A |
| | (Parts) | 0.3 | 1.0 | 0.1 | 0.1 |
| Charge control | Functional group amount | 0.5 | 0.5 | 0.5 | 0.5 |
| resin | (% by mass) | | | | |
| | (Parts) | 5 | 5 | 5 | 5 |
| Styrene-based | (Parts) | 2 | 2 | 2 | 2 |
| thermoplastic | | | | | |
| elastomer | | | | | |
| Acidic group- | (Parts) | 1 | 1 | 1 | 1 |
| containing | | | | | |
| acrylic resin | | | | | |
| Toner | Average circularity | 0.990 | 0.988 | 0.980 | 0.985 |
| evaluation | Dv/Dp | 1.10 | 1.10 | 1.18 | 1.11 |
| | Heat resistant | B | B | A | A |
| | temperature | | | | |
| | Fixing temperature | A | A | A | B |
| | Initial fogging test | A | C | B | B |
| | Gloss unevenness | A | A | A | A |
| | Surfactant amount (ppm) | 100 | 400 | 48 | 48 |
| | on toner particle surface | | | | |
| | Electrical conductivity | 11 | 12 | 29 | 31 |
| | (μS/cm) of toner extract | | | | |

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Toner No. | | Y-8 | Y-9 | Y-10 | Y-11 | Y-12 | Y-13 |
| Binder resin | Styrene (Parts) | 74 | 74 | 74 | 74 | 74 | 74 |
| | Butyl acrylate | 26 | 26 | 26 | 26 | 26 | 26 |
| | (Parts) | | | | | | |
| | AA-6 (Parts) | 0.1 | 0.1 | 0.1 | 0.1 | 0.1 | 0.1 |
| | Polyester resin | | 5 | 5 | 5 | 5 | 5 |
| | (1) (Parts) | | | | | | |
| | Polyester resin | | | | | | |
| | (2) (Parts) | | | | | | |
| Styrene-acrylic resin:Polyester | | 95.2:4.8 | 95.2:4.8 | 95.2:4.8 | 95.2:4.8 | 95.2:4.8 | 95.2:4.8 |
| resin (Mass ratio) | | | | | | | |
| Colorant | Type | Yellow pigment | Yellow pigment | Yellow pigment | Yellow pigment | Yellow pigment | Yellow pigment |
| | | (PY214, SY98) | (PY214, SY98) | (PY214, SY98) | (PY214, SY98) | (PY214, SY98) | (PY214, SY98) |
| | (Parts) | 8 | 8 | 8 | 8 | 8 | 8 |
| Release | Type | Ester wax 1 | Ester wax 1 | Ester wax 1 | Hydrocarbon | Ester wax 1 | Ester wax 1 |
| agent | | | | | wax | | |
| | (Parts) | 12 | 12 | 12 | 12 | 12 | 12 |
| Release | Type | Nonionic | | Nonionic | Nonionic | Anionic | Cationic |
| agent | | surfactant A | | surfactant A | surfactant A | surfactant A | surfactant A |
| disperser | (Parts) | 0.1 | 0 | 1.5 | 0.1 | 0.1 | 0.1 |
| Charge | Functional | 0.5 | 0.5 | 0.5 | 0.5 | 0.5 | 0.5 |
| control | group amount | | | | | | |
| resin | (% by mass) | | | | | | |
| | (Parts) | 5 | 5 | 5 | 5 | 5 | 5 |
| Styrene-based | (Parts) | 2 | 2 | 2 | 2 | 2 | 2 |
| thermoplastic | | | | | | | |
| elastomer | | | | | | | |
| Acidic group- | (Parts) | 1 | 1 | 1 | 1 | 1 | 1 |
| containing | | | | | | | |
| acrylic resin | | | | | | | |
| Toner | Average | 0.993 | 0.985 | 0.980 | 0.985 | 0.975 | 0.974 |
| evaluation | circularity | | | | | | |
| | Dv/Dp | 1.11 | 1.11 | 1.14 | 1.11 | 1.11 | 1.11 |
| | Heat resistant | B | C | D | C | B | B |
| | temperature | | | | | | |
| | Fixing | D | D | B | C | B | B |
| | temperature | | | | | | |
| | Initial fogging | A | C | D | D | D | D |
| | test | | | | | | |
| | Gloss unevenness | B | A | B | D | A | A |
| | Surfactant amount | 48 | 0 | 600 | 510 | 48 | 48 |
| | (ppm) on toner | | | | | | |
| | particle surface | | | | | | |
| | Electrical | 33 | 26 | 44 | 34 | 51 | 54 |
| | conductivity | | | | | | |
| | (μS/cm) of | | | | | | |
| | toner extract | | | | | | |

TABLE 3

| | | Example 10 | Example 11 | Example 12 | Example 13 |
|---|---|---|---|---|---|
| Toner No. | | M-2 | Y-14 | Y-15 | Y-16 |
| Binder resin | Styrene (Parts) | 74 | 74 | 74 | 74 |
| | Butyl acrylate (Parts) | 26 | 26 | 26 | 26 |
| | AA-6 (Parts) | 0.1 | 0.1 | 0.1 | 0.1 |
| | Polyester resin (1) (Parts) | 5 | 5 | 5 | 5 |
| | Polyester resin (2) (Parts) | | | | |
| Styrene-acrylic resin:Polyester | | 95.2:4.8 | 95.2:4.8 | 95.2:4.8 | 95.2:4.8 |
| resin (Mass ratio) | | | | | |
| Colorant | Type | Magenta pigment A | Yellow pigment | Yellow pigment | Yellow pigment |
| | | (PR122, PV19) | (PY214, SY98) | (PY214, SY88) | (PY214, SY98) |
| | (Parts) | 8 | 8 | 8 | 8 |
| Release agent | Ester wax 1 (Parts) | 12 | 12 | 12 | |
| | Ester wax 2 (Parts) | | | | 12 |
| | Ester wax 3 (Parts) | | | | |
| | Hydrocarbon wax (Parts) | | | | |
| Release agent | Nonionic surfactant A (Parts) | 0.1 | 0.05 | 0.1 | 0.1 |
| disperser | Nonionic surfactant D (Parts) | | | | |
| | Anionic surfactant B (Parts) | | | | |
| | Anionic surfactant C (Parts) | | | | |
| Charge control | Functional group amount | 0.5 | 0.5 | 15 | 0.5 |
| resin | (% by mass) | | | | |
| | (Parts) | 5 | 5 | 5 | 5 |
| Styrene-based | (Parts) | 0 | 2 | 2 | 2 |
| thermoplastic | | | | | |
| elastomer | | | | | |
| Acidic group- | (Parts) | 1 | 1 | 1 | 1 |
| containing | | | | | |
| acrylic resin | | | | | |
| Toner | Average circularity | 0.992 | 0.985 | 0.992 | 0.992 |
| evaluation | Dv/Dp | 1.10 | 1.11 | 1.10 | 1.10 |
| | Heat resistant temperature | A | A | B | C |
| | Fixing temperature | B | B | A | A |
| | Initial fogging test | A | B | B | A |
| | Gloss unevenness | B | A | A | A |
| | (Total) surfactant amount | 48 | 25 | 48 | 48 |
| | (ppm) on toner particle surface | | | | |
| | Nonionic surfactant amount | 48 | 25 | 48 | 48 |
| | (ppm) on toner particle surface | | | | |
| | Anionic surfactant amount | 0 | 0 | 0 | 0 |
| | (ppm) on toner particle surface | | | | |
| | Electrical conductivity | 22 | 40 | 35 | 30 |
| | (μS/cm) of toner extract | | | | |

| | | Example 14 | Example 15 | Example 16 |
|---|---|---|---|---|
| Toner No. | | Y-17 | C-2 | M-3 |
| Binder resin | Styrene (Parts) | 74 | 74 | 74 |
| | Butyl acrylate (Parts) | 26 | 26 | 26 |
| | AA-6 (Parts) | 0.1 | 0.1 | 0.1 |
| | Polyester resin (1) (Parts) | 5 | 5 | 5 |
| | Polyester resin (2) (Parts) | | | |
| Styrene-acrylic resin:Polyester | | 95.2:4.8 | 95.2:4.8 | 95.2:4.8 |
| resin (Mass ratio) | | | | |
| Colorant | Type | Yellow pigment | Cyan pigment | Magenta pigment |
| | | (PY214, SY98) | (PB15:3) | (PR122) |
| | (Parts) | 8 | 5 | 8 |
| Release agent | Ester wax 1 (Parts) | | 12 | 12 |
| | Ester wax 2 (Parts) | | | |
| | Ester wax 3 (Parts) | 12 | | |
| | Hydrocarbon wax (Parts) | | | |
| Release agent | Nonionic surfactant A (Parts) | 0.1 | 0.1 | 0.1 |
| disperser | Nonionic surfactant D (Parts) | | | |
| | Anionic surfactant B (Parts) | | | |
| | Anionic surfactant C (Parts) | | | |
| Charge control | Functional group amount | 0.5 | 0.5 | 0.5 |
| resin | (% by mass) | | | |
| | (Parts) | 5 | 5 | 5 |
| Styrene-based | (Parts) | 2 | 2 | 2 |
| thermoplastic | | | | |
| elastomer | | | | |
| Acidic group- | (Parts) | 1 | 1 | 1 |
| containing | | | | |
| acrylic resin | | | | |
| Toner | Average circularity | 0.992 | 0.99 | 0.969 |
| evaluation | Dv/Dp | 1.10 | 1.12 | 1.13 |
| | Heat resistant temperature | B | A | A |
| | Fixing temperature | A | A | A |
| | Initial fogging test | A | A | A |
| | Gloss unevenness | A | A | A |
| | (Total) surfactant amount | 48 | 48 | 48 |
| | (ppm) on toner particle surface | | | |
| | Nonionic surfactant amount | 48 | 48 | 48 |
| | (ppm) on toner particle surface | | | |
| | Anionic surfactant amount | 0 | 0 | 0 |
| | (ppm) on toner particle surface | | | |
| | Electrical conductivity | 23 | 27 | 20 |
| | (μS/cm) of toner extract | | | |

| | | Example 17 | Example 18 | Example 19 | Example 20 |
|---|---|---|---|---|---|
| Toner No. | | Y-18 | Y-19 | Y-20 | Y-21 |
| Binder resin | Styrene (Parts) | 74 | 74 | 74 | 74 |
| | Butyl acrylate (Parts) | 26 | 26 | 26 | 26 |
| | AA-6 (Parts) | 0.1 | 0.1 | 0.1 | 0.1 |
| | Polyester resin (1) (Parts) | 5 | 5 | 5 | 5 |
| | Polyester resin (2) (Parts) | | | | |
| Styrene-acrylic resin:Polyester | | 95.2:4.8 | 95.2:4.8 | 95.2:4.8 | 95.2:4.8 |
| resin (Mass ratio) | | | | | |
| Colorant | Type | Yellow pigment | Yellow pigment | Yellow pigment | Yellow pigment |
| | | (PY214, SY98) | (PY214, SY98) | (PY214, SY98) | (PY214, SY98) |
| | (Parts) | 8 | 8 | 8 | 8 |
| Release agent | Ester wax 1 (Parts) | 8 | 16 | 6 | 10 |
| | Ester wax 2 (Parts) | | | 6 | |
| | Ester wax 3 (Parts) | | | | |
| | Hydrocarbon wax (Parts) | | | | 2 |
| Release agent | Nonionic surfactant A (Parts) | 0.06 | 1.3 | 0.1 | 0.1 |
| disperser | Nonionic surfactant D (Parts) | | | | |
| | Anionic surfactant B (Parts) | | | | |
| | Anionic surfactant C (Parts) | | | | |
| Charge control | Functional group amount | 0.5 | 0.5 | 0.5 | 0.5 |
| resin | (% by mass) | | | | |
| | (Parts) | 5 | 5 | 5 | 5 |
| Styrene-based | (Parts) | 2 | 2 | 2 | 2 |
| thermoplastic | | | | | |
| elastomer | | | | | |
| Acidic group- | (Parts) | 1 | 1 | 1 | 1 |
| containing | | | | | |
| acrylic resin | | | | | |
| Toner | Average circularity | 0.985 | 0.984 | 0.991 | 0.987 |
| evaluation | Dv/Dp | 1.12 | 1.14 | 1.12 | 1.12 |
| | Heat resistant temperature | A | B | B | B |
| | Fixing temperature | B | A | A | B |
| | Initial fogging test | A | C | A | B |
| | Gloss unevenness | A | A | A | B |
| | (Total) surfactant amount | 30 | 500 | 48 | 48 |
| | (ppm) on toner particle surface | | | | |
| | Nonionic surfactant amount | 30 | 500 | 48 | 48 |
| | (ppm) on toner particle surface | | | | |
| | Anionic surfactant amount | 0 | 0 | 0 | 0 |
| | (ppm) on toner particle surface | | | | |
| | Electrical conductivity | 16 | 14 | 24 | 34 |
| | (μS/cm) of toner extract | | | | |

| | | Example 21 | Example 22 | Example 23 |
|---|---|---|---|---|
| Toner No. | | Y-22 | Y-23 | Y-24 |
| Binder resin | Styrene (Parts) | 74 | 74 | 74 |
| | Butyl acrylate (Parts) | 26 | 26 | 26 |
| | AA-6 (Parts) | 0.1 | 0.1 | 0.1 |
| | Polyester resin (1) (Parts) | 5 | 5 | 5 |
| | Polyester resin (2) (Parts) | | | |
| Styrene-acrylic resin:Polyester | | 95.2:4.8 | 95.2:4.8 | 95.2:4.8 |
| resin (Mass ratio) | | | | |
| Colorant | Type | Yellow pigment | Yellow pigment | Yellow pigment |
| | | (PY214, SY98) | (PY214, SY98) | (PY214, SY98) |
| | (Parts) | 8 | 8 | 8 |
| Release agent | Ester wax 1 (Parts) | 12 | 12 | 12 |
| | Ester wax 2 (Parts) | | | |
| | Ester wax 3 (Parts) | | | |
| | Hydrocarbon wax (Parts) | | | |
| Release agent | Nonionic surfactant A (Parts) | 0.05 | 0.05 | 0.05 |
| disperser | Nonionic surfactant D (Parts) | | | 0.05 |
| | Anionic surfactant B (Parts) | 0.05 | | |
| | Anionic surfactant C (Parts) | | 0.05 | |
| Charge control | Functional group amount | 0.5 | 0.5 | 0.5 |
| resin | (% by mass) | | | |
| | (Parts) | 5 | 5 | 5 |
| Styrene-based | (Parts) | 2 | 2 | 2 |
| thermoplastic | | | | |
| elastomer | | | | |
| Acidic group- | (Parts) | 1 | 1 | 1 |
| containing | | | | |
| acrylic resin | | | | |
| Toner | Average circularity | 0.987 | 0.984 | 0.988 |
| evaluation | Dv/Dp | 1.12 | 1.13 | 1.11 |
| | Heat resistant temperature | B | B | B |
| | Fixing temperature | A | A | A |
| | Initial fogging test | C | C | A |
| | Gloss unevenness | B | B | A |
| | (Total) surfactant amount | 48 | 48 | 48 |
| | (ppm) on toner particle surface | | | |
| | Nonionic surfactant amount | 24 | 24 | 48 |
| | (ppm) on toner particle surface | | | |
| | Anionic surfactant amount | 24 | 24 | 0 |
| | (ppm) on toner particle surface | | | |
| | Electrical conductivity | 34 | 36 | 21 |
| | (μS/cm) of toner extract | | | |

### Consideration

The toner of Comparative Example 1 had poor low temperature fixability since it did not contain a polyester resin as the binder resin.

The toner of Comparative Example 2 had poor low temperature fixability since it did not contain a release agent disperser.

In the toner of Comparative Example 3, since the amount of the nonionic surfactant added as the release agent disperser was large, the mass of the nonionic surfactant present on the surface of the toner particles was more than 500 ppm. Accordingly, the toner had poor heat-resistant storage stability, and fogging was likely to occur.

The toner of Comparative Example 4 did not contain an ester wax as the release agent; it contained the hydrocarbon wax; and the mass of the nonionic surfactant present on the surface of the toner particles was more than 500 ppm. Accordingly, fogging was likely to occur, and gloss unevenness was likely to be caused. It is considered that the hydrocarbon wax easily caused gloss unevenness, since the crystallization speed of the wax when the fixed toner was quickly cooled down, was fast. The hydrocarbon wax was less likely to dissolve the surfactant, and it is considered that since the surfactant was separated and localized on the toner particle surface, the amount of the nonionic surfactant present on the surface of the toner particles of Comparative Example 4 was large.

The toners of Comparative Examples 5 and 6 were likely to cause fogging since the ionic surfactant was used as the release agent disperser, without the use of a nonionic surfactant. It is considered that this is because, since the ionic surfactant was likely to affect the chargeability of the toner compared to the nonionic surfactant, the chargeability of the toner was unstable.

The toners of Examples 1 to 9 were the positively-chargeable toners of the present disclosure, in each of which the binder resin contained a styrene-acrylic resin and a polyester resin; the release agent contained an ester wax; and the release agent disperser contained a nonionic surfactant, and the mass of the nonionic surfactant present on the surface of toner particles was from 30 ppm to 500 ppm with respect to the mass of the toner particles. Accordingly, the toners of Examples 1 to 9 were toners which were excellent in low temperature fixability and heat-resistant storage stability and which were less likely to cause fogging, and they formed images with less gloss unevenness.

From a comparison between Examples 1 to 5, it is shown that when the nonionic surfactant A (a polyoxyalkylene distyrenated aryl ether surfactant) is used as the release agent disperser, the toner thus obtained tends to be excellent in low temperature fixability and heat-resistant storage stability.

From a comparison between Example 7 and Examples 1 to 6, 8 and 9, it is shown that fogging is likely to be suppressed when the mass of the nonionic surfactant present on the surface of the toner particles is less than 400 ppm.

From a comparison between Example 1 and Example 9, it is shown that when the polyester resin (1) having a number average molecular weight of 8,000 or less and a weight average molecular weight of 20,000 or less is used as the polyester resin, the toner thus obtained tends to be excellent in low temperature fixability and less likely to cause fogging, compared to the case of using the polyester resin (2) having a number average molecular weight of more than 8,000 and a weight average molecular weight of more than 20,000.

The toners of Examples 10 to 23 are the positively-chargeable toners of the present disclosure, in each of which the binder resin contained a styrene-acrylic resin and a polyester resin; the release agent contained an ester wax; and the release agent disperser contained a nonionic surfactant, and the mass of the nonionic surfactant present on the surface of toner particles was from 0.1 ppm to 500 ppm with respect to the mass of the toner particles. Accordingly, the toners of Examples 10 to 23 were toners which were excellent in low temperature fixability and heat-resistant storage stability and which were less likely to cause fogging, and they formed images with less gloss unevenness.

From Examples 10, 11 and 12, it is shown that even when the toner of the present disclosure does not contain a styrene-based thermoplastic elastomer, even when the mass of the nonionic surfactant is less than 30 ppm, or even when the functional group amount of the charge control resin is large, the toner of the present disclosure can exert the following effects: the toner has an excellent balance between low temperature fixability and heat-resistant storage stability; the toner is less likely to cause fogging; and the toner can form an image with excellent gloss uniformity. From a comparison between Example 10 and Example 1, it is shown that when the toner of the present disclosure contains a styrene-based thermoplastic elastomer, the low temperature fixability is improved, and gloss unevenness is suppressed.

From Examples 13 and 14, it is shown that the above-mentioned effects are obtained even when a polyfunctional ester wax other than a glycerin ester compound or a monoester compound is used as the release agent. Meanwhile, from a comparison between Example 13, Example 14 and Example 1, it is shown that when a glycerin ester compound is used as the release agent, the balance between the storage stability and low temperature fixability of the toner is the best.

From a comparison between Example 15 and Example 2, the above-mentioned effects are obtained even when the colorant amount is changed.

From a comparison between Example 16 and Example 3, it is shown that the above-mentioned effects are obtained even when the toner of the present disclosure uses C.I. Pigment Red 122 alone as the colorant.

From Example 17 and 18, it is shown that in the toner of the present disclosure, by controlling the amount of the added release agent disperser depending on the content of the release agent, the dispersibility of the release agent can be improved, and the balance between the storage stability and low temperature fixability of the toner can be excellent. From the result of Example 17, it is shown that the fixing temperature tends to increase when the content of the release agent is small. From the result of Example 18, it is shown that blocking and fogging are likely to occur when the content of the release agent is large.

From Examples 19 and 20, it is shown that that the above-mentioned effects are obtained even when the toner of the present disclosure contains two or more kinds of ester waxes as the release agent or even when it contains a combination of an ester wax and a hydrocarbon wax.

From Examples 21 and 22, it is shown that the above-mentioned effects are obtained even when the toner of the present disclosure contains the combination of the nonionic surfactant and the ionic surfactant as the release agent disperser.

From Example 23, it is shown that the above-mentioned effects are obtained even when the toner of the present disclosure contains two or more kinds of nonionic surfactants as the release agent disperser.

### [Toner Set]

Toner sets 1 to 10 were obtained by combining, according to Table 4, a toner which is transferred first (an initial color toner), a different color toner which is transferred second (a different color toner 1) and a different color toner which is transferred third (a different color toner 2).

The toner sets were evaluated as follows.

### [Evaluation For Gloss Unevenness]

Printing paper sheets and a developing apparatus in which multiple toner developing devices were installed, were set in a commercially-available, non-magnetic one-component developing printer (printing speed: 20 sheets/min). According to Table 4, the initial color toner, the different color toner 1 or the different color toner 2 was put in each of the toner developing devices. Overprinting was carried out in an environment at a temperature of 23° C. and a humidity of 50%, and solid pattern printing of a tertiary color at a printing density of 100% was carried out to form, on a transfer paper, a 5 cm×5 cm square at a position 0.5 cm away from the leading edge of the paper. At that time, a primary color image formed with the initial color toner, a primary color image formed with the different color toner 1, and a primary color image formed with the different color toner 2 were transferred in this order onto a printing paper sheet, thereby forming a tertiary color image. Also, the developing amount M/A, which is the amount of the toner on the printing paper sheet, was changed by changing the developing bias voltage. The developing amount M/A was calculated as follows: an unfixed image was removed from the printer; the toner developed on the printing paper sheet was blown off by air; and the developing amount M/A was calculated by the following formula.

$$M / A ( mg / {cm}^{2} ) = ( {W}_{1} - {W}_{2} ) / 25 {cm}^{2}$$

W₁: The weight (mg) of the printing paper sheet before the toner was blown off.
W₂: The weight (mg) of the printing paper sheet after the toner was blown off.

The unfixed image of the tertiary color, which had a M/A of 0.70 mg/cm², was fixed on a printing paper sheet by a fixing roller at 160° C. to obtain a fixed image of a 5 cm×5 cm square solid pattern of the tertiary color. At the four corners and center of the obtained solid image of 5 cm square, that is, at the total of 5 points, the gloss value was measured with a gloss meter (product name: VGS-SENSOR, manufactured by: Nippon Denshoku Industries Co., Ltd.) at an incident angle of 60°. From the gloss values of the 5 points, the maximum and minimum values were obtained; the average value of the 5 gloss values was obtained; and the gloss unevenness was calculated by the following calculation formula.

$$Gloss unevenness ( \% ) = \{ ( Maximum value - Minimum value ) / Average value \} \times 100$$

In the following evaluation criteria, it can be evaluated that the gloss unevenness diminishes and the toner improves in the order of C<B<A, and D is failure.

### (Evaluation Criteria for Gloss Unevenness)

A: The gloss unevenness was less than 20%.
B: The gloss unevenness was 20% or more and less than 25%.
C: The gloss unevenness was 25% or more and less than 30%.
D: The gloss unevenness was 30% or more.

### [Evaluation for Peeling]

Printing paper sheets and a developing apparatus in which multiple toner developing devices were installed, were set in a commercially-available, non-magnetic one-component developing printer (printing speed: 20 sheets/min) that was modified such that the temperature of the fixing roller was changeable. According to Table 4, the initial color toner, the different color toner 1, or the different color toner 2 was put in each of the toner developing devices. Overprinting was carried out in an environment at a temperature of 23° C. and a humidity of 50%, and solid pattern printing of a tertiary color at a printing density of 100% was carried out to form, on a transfer paper, a 5 cm×20 cm rectangle at a position 0.5 cm away from the leading edge of the paper. At that time, a primary color image formed with the initial color toner, a primary color image formed with the different color toner 1, and a primary color image formed with the different color toner 2 were transferred in this order onto a printing paper sheet, thereby forming a tertiary color image. While the temperature of the fixing roller of the printer was changed 5° C. by 5° C. from 200° C. to 150° C., solid pattern printing of the tertiary color was carried out at each fixing temperature. The thus-obtained solid pattern of the tertiary color was visually confirmed to check whether peeling of the toner layers from the paper sheet surface, peeling between the toner layers, or peeling occurring within the toner layer(s) occurred or not. The temperature of the fixing roller (i.e., the fixing temperature) at the time when peeling occurred during the solid pattern printing was determined as the peeling occurrence temperature.

The evaluation was made based on the following four criteria: A, B, C and D. It can be evaluated that as the peeling occurrence temperature decreases, the fixation of the toner layers improves, and the peeling is suppressed. Accordingly, it can be evaluated that the fixation of the toner layers improves in the order of C<B<A, and D is failure.

### <Evaluation Criteria for Peeling>

A: The peeling occurrence temperature was 160° C. or less.
B: The peeling occurrence temperature was more than 160° C. and 165° C. or less.
C: The peeling occurrence temperature was more than 165° C. and 170° C. or less.
D: The peeling occurrence temperature was more than 170° C.

TABLE 4

| Toner set No. | | Toner set 1 | Toner set 2 | Toner set 3 | Toner set 4 | Toner set 5 |
|---|---|---|---|---|---|---|
| Initial | Example No. | Example 3 | Example 10 | Example 16 | Example 10 | Example 5 |
| color | Toner No. | M-1 | M-2 | M-3 | M-2 | Y-3 |
| toner | | | | | | |
| Different | Example No. | Example 1 | Example 1 | Example 2 | Example 2 | Example 2 |
| color | Toner No. | Y-1 | Y-1 | C-1 | C-1 | C-1 |
| toner 1 | | | | | | |
| Different | Example No. | Example 2 | Example 15 | Example 1 | Example 20 | Example 16 |
| color | Toner No. | C-1 | C-2 | Y-1 | Y-21 | M-3 |
| toner 2 | | | | | | |
| Evaluation | Gloss | A | A | A | B | B |
| | unevenness | | | | | |
| | Peeling | A | B | A | B | A |
| Toner set No. | | Toner set 6 | Toner set 7 | Toner set 8 | Toner set 9 | Toner set 10 |
| Initial | Example No. | Example 20 | Example 10 | Example 10 | Comparative | Comparative |
| color | | | | | Example 3 | Example 4 |
| toner | Toner No. | Y-21 | M-2 | M-2 | Y-10 | Y-11 |
| Different | Example No. | Example 2 | Comparative | Comparative | Example 2 | Example 2 |
| color | | | Example 1 | Example 2 | | |
| toner 1 | Toner No. | C-1 | Y-8 | Y-9 | C-1 | C-1 |
| Different | Example No. | Example 3 | Example 2 | Example 15 | Example 16 | Example 16 |
| color | Toner No. | M-1 | C-1 | C-2 | M-3 | M-3 |
| toner 2 | | | | | | |
| Evaluation | Gloss | B | C | C | B | D |
| | unevenness | | | | | |
| | Peeling | B | D | D | D | C |

### Consideration

In the toner sets 1 to 6, all the color toners constituting the toner set were the toners of the present disclosure. Accordingly, the higher-order color images formed by use of the toner sets 1 to 6 (solid patterns of the tertiary color) had less gloss unevenness; moreover, their peeling occurrence temperatures were low, that is, peeling of the toner layer(s) was suppressed.

Meanwhile, the toner set 7 included the toner (Y-8) of Comparative Example 1 which did not contain a polyester resin as the binder resin. Accordingly, the higher-order color image formed by use of the toner set 7 had large gloss unevenness compared to the cases that used the toner sets 1 to 6. It is estimated that this is because, since the toner (Y-8) of Comparative Example 1 insufficiently melted, the interfaces between the toner layers formed with the toner (Y-8) were roughened. Also, the toner layers of the higher-order color image formed by use of the toner set 7 were likely to peel. It is estimated that this is because, since the toner (Y-8) insufficiently melted, the adhesion of the interfaces between the toner layers formed with the toner (Y-8) was insufficient.

The toner set 8 included the toner (Y-9) of Comparative Example 2 which did not use a release agent disperser. Accordingly, the higher-order color image formed by use of the toner set 8 had large gloss unevenness compared to the cases that used the toner sets 1 to 6. It is estimated that this is because, since the ester wax was non-uniformly dispersed in the toner (Y-9) of Comparative Example 2 and, as a result, the toner (Y-9) insufficiently melted, the interfaces between the toner layers formed with the toner (Y-9) were roughened. Also, the toner layers of the higher-order color image formed by use of the toner set 8 were likely to peel. It is estimated that this is because, since the toner (Y-9) insufficiently melted, the adhesion of the toner layers formed with the toner (Y-9) was insufficient.

The toner set 9 included the toner (Y-10) of Comparative Example 3 in which the mass of the nonionic surfactant present on the surface of the toner particles was more than 500 ppm. Accordingly, the toner layers of the higher-order color image formed by use of the toner set 9 was likely to peel. It is estimated that this is because interfacial peeling occurred between the toner particles forming the toner layers, since the amount of the nonionic surfactant added to the toner (Y-10) of Comparative Example 3 was too large and, as a result, the release agent was excessively finely dispersed and was thus likely to seep out to the surface of the toner particles when fixing the toner.

The toner set 10 included the toner (Y-11) of Comparative Example 4 that contained only the hydrocarbon wax as the release agent. Accordingly, the higher-order color image formed with the toner set 10 had large gloss unevenness. It is considered that this is because the crystallization speed of the hydrocarbon wax contained in the toner (Y-11) of Comparative Example 4 was fast. Also, the toner layers of the higher-order color image formed by use of the toner set 10 were likely to peel compared to the cases that used the toner sets 1 to 6. The reason is considered as follows: in the toner (Y-11) of Comparative Example 4, since the compatibility between the binder resin and release agent was too high and the release agent seeped out to the surface of the toner particles when fixing the toner, accordingly, interfacial peeling occurred between the toner particles.

1. A positively-chargeable toner for developing electrostatic images, comprising colored resin particles which contain a binder resin, a colorant, a release agent, a release agent disperser and a charge control agent,
wherein the binder resin comprises a styrene-acrylic resin and a polyester resin;
wherein the release agent comprises an ester wax; and
wherein the release agent disperser comprises a nonionic surfactant, and a mass of the nonionic surfactant which is present on a surface of toner particles is from 30 ppm to 500 ppm with respect to a mass of the toner particles.

2. A positively-chargeable toner for developing electrostatic images, comprising colored resin particles which contain a binder resin, a colorant, a release agent, a release agent disperser and a charge control agent,
wherein the binder resin comprises a styrene-acrylic resin and a polyester resin;
wherein the release agent comprises an ester wax; and
wherein the release agent disperser comprises a nonionic surfactant, and a mass of the nonionic surfactant which is present on a surface of toner particles is 0.1 ppm or more and less than 30 ppm with respect to a mass of the toner particles.

3. The positively-chargeable toner for developing electrostatic images according to claim 1, wherein the charge control agent comprises a charge control resin.

4. The positively-chargeable toner for developing electrostatic images according to claim 1, wherein a mass ratio of the styrene-acrylic resin to the polyester resin (the styrene-acrylic resin:the polyester resin) is from 96:4 to 70:30.

5. The positively-chargeable toner for developing electrostatic images according to claim 1, wherein the colored resin particles further contain a styrene-based thermoplastic elastomer.

6. The positively-chargeable toner for developing electrostatic images according to claim 1, wherein the toner particles have an average circularity of 0.96 or more, and they have a particle size distribution (Dv/Dp) of less than 1.3, which is a ratio of a volume average particle diameter (Dv) to number average particle diameter (Dp) of the toner particles.

7. The positively-chargeable toner for developing electrostatic images according to claim 1, wherein the ester wax comprises a polyfunctional ester compound of a polyhydric alcohol and a fatty acid containing 10 to 22 carbon atoms.

8. A toner set which is a color toner set comprising positively-chargeable toners of multiple colors for developing electrostatic images,
wherein the positively-chargeable toners of multiple colors for developing electrostatic images comprise at least a yellow toner, a magenta toner and a cyan toner, and
wherein all of the positively-chargeable toners of multiple colors for developing electrostatic images are those defined by claim 1.

9. An image forming method for forming an image using the toner set defined by claim 8.

10. The positively-chargeable toner for developing electrostatic images according to claim 2, wherein the charge control agent comprises a charge control resin.

11. The positively-chargeable toner for developing electrostatic images according to claim 2, wherein a mass ratio of the styrene-acrylic resin to the polyester resin (the styrene-acrylic resin:the polyester resin) is from 96:4 to 70:30.

12. The positively-chargeable toner for developing electrostatic images according to claim 2, wherein the colored resin particles further contain a styrene-based thermoplastic elastomer.

13. The positively-chargeable toner for developing electrostatic images according to claim 2, wherein the toner particles have an average circularity of 0.96 or more, and they have a particle size distribution (Dv/Dp) of less than 1.3, which is a ratio of a volume average particle diameter (Dv) to number average particle diameter (Dp) of the toner particles.

14. The positively-chargeable toner for developing electrostatic images according to claim 2, wherein the ester wax comprises a polyfunctional ester compound of a polyhydric alcohol and a fatty acid containing 10 to 22 carbon atoms.

15. A toner set which is a color toner set comprising positively-chargeable toners of multiple colors for developing electrostatic images,
wherein the positively-chargeable toners of multiple colors for developing electrostatic images comprise at least a yellow toner, a magenta toner and a cyan toner, and
wherein all of the positively-chargeable toners of multiple colors for developing electrostatic images are those defined by claim 2.

16. An image forming method for forming an image using the toner set defined by claim 15.
